(19) United States
(12) Patent Application Publication
(10) Pub. No.: US 2012/0164669 A1
(43) Pub. Date: Jun. 28, 2012

(54) MARKER PANEL FOR LEFT VENTRICULAR HYPERTROPHY

(75) Inventors: Georg Hess, Mainz (DE); Andrea Horsch, Mannheim (DE); Dietmar Zdunek, Tutzing (DE)

(73) Assignee: ROCHE DIAGNOSTICS OPERATIONS, INC., Indianapolis, IN (US)

(21) Appl. No.: 13/416,579

(22) Filed: Mar. 9, 2012

Related U.S. Application Data
(63) Continuation of application No. PCT/EP2010/063637, filed on Sep. 16, 2010.

(30) Foreign Application Priority Data
Sep. 17, 2009 (EP) 09011888.6

(51) Int. Cl. G01N 21/76

(52) U.S. Cl. 435/7.94

(57) ABSTRACT

The present disclosure relates to methods, compositions, kits and devices for diagnosing, distinguishing and/or facilitating a therapeutic decision in a subject having left ventricular hypertrophy. In some aspects, the methods, compositions, kits and devices disclosed herein allow for diagnosing, distinguishing and/or facilitating a therapeutic decision in a subject having physiological left ventricular hypertrophy, and/or for a subject suffering from pathological left ventricular hypertrophy.

### RELATED APPLICATIONS

This application is a continuation of International Application No. PCT/EP2010/063637, filed Sep. 16, 2010, which claims the benefit of European Patent Application No. 09011888.6, filed Sep. 17, 2009, the disclosures of which are hereby incorporated by reference in their entirety.

### BACKGROUND

Left ventricular hypertrophy (LVH) is a condition in which the walls of the ventricle thicken. This phenomenon can result from various reasons. For example, it is found in athlete's hearts (athletic heart syndrome) as adaptation to enhanced needs for blood supply and does not require any treatment.

Left ventricular hypertrophy is also found in patients suffering from arterial hypertension, i.e. high blood pressure being a disease requiring treatment. This form is generally referred to as “hypertensive left ventricular hypertrophy”. Furthermore, left ventricular hypertrophy can be caused by aortic stenosis, a condition also generally referred to as “hypertrophy associated with aortic stenosis”. Both hypertensive left ventricular hypertrophy and hypertrophy associated with aortic stenosis are included within the term “pressure overload hypertrophy”. A further cause of LVH is hypertrophic cardiomyopathy, a primary disease of the heart muscle. Hypertrophic cardiomyopathy includes a group of heart disorders in which the walls of the ventricles thicken (hypertrophy) and become stiff. In some people, the thickened muscle obstructs the flow of blood out of the heart below the aortic valve. This variation is called hypertrophic obstructive cardiomyopathy. Treatment for LVH differs among the various forms of the disease (athlete's heart, obstructive and non-obstructive hypertrophic cardiomyopathy and pressure overload hypertrophy).

### SUMMARY OF THE DISCLOSURE

The present disclosure relates to a method for diagnosing, in a subject having left ventricular hypertrophy, if the subject has physiological left ventricular hypertrophy or suffers from pathological left ventricular hypertrophy (hypertrophic obstructive cardiomyopathy, hypertrophic non-obstructive cardiomyopathy and/or pressure overload hypertrophy). Further, the present disclosure relates to a method for distinguishing or diagnosing, in a subject suffering from pathological left ventricular hypertrophy, which form of hypertrophy (hypertrophic non-obstructive cardiomyopathy, hypertrophic obstructive cardiomyopathy or pressure overload hypertrophy) the subject suffers from. The diagnosis may be carried out by measuring at least one marker selected from necrosis markers, at least one marker selected from cardiac function markers and at least one marker selected from inflammatory markers, in particular the three markers being selected from cardiac troponins, natriuretic peptides, and GDF-15. Optionally, as a further marker PIGF is measured. In one embodiment, the ratio of the various determined marker levels may be formed. The method can also be used for deciding on the therapy of the various forms of left ventricular hypertrophy and for monitoring the therapy. Moreover, the present disclosure relates to a device and a kit adapted to carry out the method of the present disclosure. Also encompassed by the present disclosure is the use of the above-specified plurality of markers for diagnosing, in a subject having left ventricular hypertrophy, the above-referenced health states.

Therefore, the present disclosure relates to a method for diagnosing or distinguishing, in a subject having left ventricular hypertrophy, if the subject has physiological left ventricular hypertrophy or suffers from pathological left ventricular hypertrophy, the method comprising the steps of:
a) determining the amounts of at least one marker selected from necrosis markers, at least one marker selected from cardiac function markers and at least one marker selected from inflammatory markers, in at least one sample of said subject,
b) comparing the thus determined amounts of the said markers as determined in step a) to suitable reference amounts, and
c) diagnosing if the subject has physiological left ventricular hypertrophy or is suffering from pathological left ventricular hypertrophy.

The method of the present disclosure may also comprise the steps of:
a) determining the amounts of at least one marker selected from necrosis markers, at least one marker selected from cardiac function markers and at least one marker selected from inflammatory markers, in at least one sample of said subject,
b) diagnosing if the subject has physiological left ventricular hypertrophy or is suffering from pathological left ventricular hypertrophy by comparing the thus determined amounts of the said markers as determined in step a) to suitable reference amounts.

The above step of diagnosing, suitable, is based on the results of said comparison and depends from the results obtained.

Thus, the present disclosure relates to a method for diagnosing or distinguishing, in a subject having left ventricular hypertrophy, if the subject has physiological left ventricular hypertrophy or suffers from pathological left ventricular hypertrophy based on the determination of at least one marker selected from necrosis markers, at least one marker selected from cardiac function markers and at least one marker selected from inflammatory markers, in at least one sample of said subject and the comparison of the determined amounts of said markers to reference amounts.

The present disclosure also relates to the use of at least one marker selected from necrosis markers, at least one marker selected from cardiac function markers and at least one marker selected from inflammatory markers for diagnosing or distinguishing, in a subject having left ventricular hypertrophy, if the subject has physiological left ventricular hypertrophy or suffers from pathological left ventricular hypertrophy.

The proteins which are measured in the context of the present disclosure can be measured in one single sample or various samples of the subject, e.g. 2, 3, 4 or 5 samples. The samples may be obtained at the same time or at different time points. For example, the samples may be collected before and/or during and/or after therapy of the patient.

In some embodiments, the cardiac function marker is a BNP-type marker or a variant thereof, such as NTproBNP or a variant thereof. in some embodiments, the necrosis marker is Troponin T or a variant thereof. In some embodiments, the inflammatory marker is GDF-15 or a variant thereof. In embodiments of the above method, the amounts of NTproBNP or a variant thereof, Troponin T or a variant thereof, and GDF-15 or a variant thereof are determined.

### DETAILED DESCRIPTION OF THE DISCLOSURE

The embodiments disclosed herein are not intended to be exhaustive or limit the disclosure to the precise form disclosed in the following detailed description. Rather, the embodiments are chosen and described so that others skilled in the art may utilize their teachings.

The method of the present disclosure permits to diagnose, in a straightforward and simple manner, if in a subject having left ventricular hypertrophy, the subject is healthy and has physiological left ventricular hypertrophy, or if the subject suffers from a pathological form of left ventricular hypertrophy, without having to refer to costly and time-consuming methods allowing to distinguish between the physiological and pathological form.

The term “diagnosing” as used herein means assessing, identifying, evaluating or classifying if a subject has physiological left ventricular hypertrophy or suffers from pathological left ventricular hypertrophy. The term “diagnosing” also refers to distinguishing between a physiologically healthy subject and a subject suffering from pathological left ventricular hypertrophy.

The term “left ventricular hypertrophy” as used herein relates to a thickening of the walls of the ventricles, as a result or not of a pathophysiological state of the subject, i.e. the underlying cause can be a disease or not. It is found in athlete's hearts (athletic heart syndrome) as adaptation to enhanced needs for blood supply and, and this case, does not require any treatment. Left ventricular hypertrophy is also found in patients suffering from arterial hypertension, i.e. high blood pressure being a disease requiring treatment. A further reason for the occurrence of left ventricular hypertrophy is an aortic stenosis requiring treatment by an intervention.

A cardiomyopathy is a primary disease of the heart muscle. Cardiomyopathies are divided into 3 main types: dilated, hypertrophic, and restrictive, based on the pathologic features. In the context of the present disclosure, only hypertrophic cardiomyopathy is relevant.

Manifestations of cardiomyopathies are usually those of heart failure and vary depending on whether there is systolic dysfunction, diastolic dysfunction, or both. Some cardiomyopathies may also cause chest pain, syncope, or sudden death.

Hypertrophic cardiomyopathy includes a group of heart disorders in which the walls of the ventricles thicken (hypertrophy) and become stiff, even though the workload of the heart is not increased. Most cases of hypertrophic cardiomyopathy are caused by an inherited genetic defect. People experience fainting, chest pain, shortness of breath, and awareness of irregular heartbeats. A diagnosis based on physical examination findings can be made, but echocardiography is used to confirm the diagnosis.

The terms “physiological”, “physiologically healthy” and “physiological left ventricular hypertrophy” refer to the state of a healthy individual exhibiting left ventricular hypertrophy. The individual does not suffer from hypertrophic non-obstructive cardiomyopathy, hypertrophic obstructive cardiomyopathy, or pressure overload hypertrophy”. It is found in athlete's hearts (athletic heart syndrome) as adaptation to enhanced needs for blood supply and, and this case, does not require any treatment. In the context of the present application, this state or phenomenon will be referred to as “physiological left ventricular hypertrophy” or “physiological hypertrophy”. The person skilled in the art is aware that this phenomenon is generally found in athlete's hearts (athletic heart syndrome) as adaptation to enhanced needs for blood supply and is not a pathological state. It does not require any treatment.

The terms “pathological” and “pathological left ventricular hypertrophy” refer to the state of a non-healthy individual exhibiting left ventricular hypertrophy. The person skilled in the art is aware that this phenomenon is found in hypertrophic cardiomyopathy, which can be sub-divided into hypertrophic non-obstructive cardiomyopathy and hypertrophic obstructive cardiomyopathy. The person skilled in the art is also aware that the non-healthy individual can also suffer from “pressure overload hypertrophy”, which can be subdivided into hypertensive left ventricular hypertrophy, which in the present application will also be referred to as “pathological hypertensive left ventricular hypertrophy”, or hypertrophy caused by aortic stenosis, which in the present application will generally be referred to as “hypertrophy associated with aortic stenosis”. All pathological states mentioned beforehand require treatment.

The person skilled in the art, furthermore, is aware of the pathomechanisms leading to the above-mentioned pathological states of left ventricular hypertrophy. These states include arterial hypertension, aortic stenosis and hypertrophic cardiomyopathy HCM.

As already mentioned beforehand, more than one pathomechanism may be the cause for the occurrence of pathological left ventricular hypertrophy in a subject.

In general, before the method of the present disclosure to distinguish between pathological and physiological left ventricular hypertrophy is carried out, left ventricular hypertrophy is diagnosed by the methods known to the person skilled in the art, in general stethoscopy and/or ECG and/or chest x-ray and/or echocardiography. In some embodiments these additional diagnostic steps are part of the present disclosure. This may also apply for the other methods of the present disclosure which relate to distinguishing between different forms of left ventricular hypertrophy, methods of therapy decisions and monitoring.

The person skilled in the art is aware of methods to diagnose if the subject suffers from physiological and/or pathological left ventricular hypertrophy. In a subject which is known to have left ventricular hypertrophy, the differentiation between pathological and physiological is in general costly, time-consuming and requires medical skill and experience. Further to the methods cited above, a diagnosis is usually established on the basis of medical history, obvious signs of a cardiac dysfunction (e.g. fatigue, fainting (syncope), chest pain, shortness of breath, awareness of irregular heartbeats (palpitations) produced by an abnormal heart rhythm (arrhythmia)) and examination of vital body functions (e.g. blood pressure).

For example, a subject is diagnosed as having cardiac left ventricular hypertrophy. In such a subject, hypertensive left ventricular hypertrophy may be diagnosed by measuring blood pressure and/or medical history. Hypertrophic cardiomyopathy can be diagnosed by exclusion of other forms of hypertrophy (as hypertensive left ventricular hypertrophy) and/or by genetic examination. A known risk factor is a family history of hypertrophic cardiomyopathy or of unexplained sudden death. In patients diagnosed with hypertrophic cardiomyopathy, obstructive hypertrophic cardiomyopathy can be diagnosed by measuring the outflow gradient.

The above-referenced methods of diagnosis (distinguishing between the various form of left ventricular hypertrophy) do not only apply in respect to distinguishing between physiological and pathological left ventricular hypertrophy, but also in respect to distinguishing between the various forms of pathological left ventricular hypertrophy, which is a further object of the present disclosure as specified hereinafter.

The present inventors found that based on the measurement of the amount of the at least one marker of the disclosure in the sample from a subject it was possible to diagnose or distinguish in a subject having left ventricular hypertrophy, if the subject has physiological left ventricular hypertrophy or suffers from pathological left ventricular hypertrophy, as it is for example evident from the examples.

In some embodiments, the method of the present disclosure is an in vitro method. In some embodiments, the amount of at least one marker is determined in a sample obtained from said subject. Moreover, it may comprise steps in addition to those explicitly mentioned above. For example, further steps may relate to sample pre-treatments or evaluation of the results obtained by the method. The method of the present disclosure may be also used for monitoring, confirmation, and subclassification of the subject. The method may be carried out manually or assisted by automation. In some embodiments, step (a), (b) and/or (c) may in total or in part be assisted by automation, e.g., by a suitable robotic and sensory equipment for the determination in step (a) or a computer-implemented calculation in step (b).

As will be understood by those skilled in the art, such an assessment is usually not intended to be correct for all (i.e. 100%) of the subjects to be identified. The term, however, requires that a statistically significant portion of subjects can be identified (e.g. a cohort in a cohort study). Whether a portion is statistically significant can be determined without further ado by the person skilled in the art using various well known statistic evaluation tools, e.g., determination of confidence intervals, p-value determination, Student's t-test, Mann-Whitney test etc.. Details are found in Dowdy and Wearden, Statistics for Research, John Wiley & Sons, New York 1983. in some embodiments, confidence intervals are at least 90%, at least 95%, at least 97%, at least 98% or at least 99%. The p-values are, in some embodiments, 0.1, 0.05, 0.01, 0.005, or 0.0001. Suitably, at least 60%, at least 70%, at least 80% or at least 90% of the subjects of a population can be properly identified by the method of the present disclosure.

The terms “individual”, “subject” and “patient” may be used interchangeably herein and relate to an animal, suitably a mammal, for example, a human.

However, it is envisaged in accordance with the aforementioned method of the present disclosure that the subject shall be a subject having left ventricular hypertrophy, wherein the hypertrophy can be physiological or pathological. Pathological hypertrophy is caused by arterial hypertension, aortic stenosis or hypertrophic cardiomyopathy. Said subject shall exhibit symptoms and/or physical signs known to be associated with arterial hypertension, aortic stenosis or hypertrophic cardiomyopathy.

The method of the present disclosure makes use of so-called “markers” or “molecular markers”. These terms are known to the person skilled in the art and refer to polypeptides or proteins which are expressed in the body of the subject. On the one hand, the expression or elevated expression can be the consequence of a pathophysiological state which has occurred or is occurring in the subject, and an elevated amount, in respect to “normal” values (which, as the case may be, can be zero) measured in a physiologically healthy subject, is indicative of the pathophysiological state (or the “disease”) occurring in the subject. On the other hand, the protein can be expressed in certain amounts in physiologically healthy subjects, and the expression is raised in consequence of a pathophysiological state which has occurred or is occurring in the subject.

In the context of the present disclosure, the markers which are measured all belong to the first group, i.e. they are expressed or expressed in higher amounts than normal if the subject suffers from a pathophysiological state or disease. All the marker types and markers employed in the present disclosure are known to the person skilled in the art.

Necrosis markers indicate cell death having occurring in the myocard of the subject, which can occur after prolonged states of ischemia or as a consequence of apoptosis.

Cardiac function markers are indicative of a malfunction of the myocard, i.e. the muscle tissue in the myocard is weaker than normal and cannot contract as does healthy tissue, meaning that the heart has to perform harder than normal to ensure a sufficient blood supply to the body.

Inflammatory markers are indicative of inflammatory processes occurring in the body of the individual. Angiogenesis markers are indicative of angiogenetic (i.e. blood vessel forming) processes occurring in the body of the individual, as a consequence of occlusion or partial occlusion of blood vessels, in general following atherosclerosis.

Patients suffering from myocardial infarction MI can be diagnosed using cardiac troponins, such as troponin T or I, for example, troponin T. Myocardial infarction is regarded as being caused by a necrotic state of the myocard, i.e. cell death. Cardiac troponins are released following cell death and can hence be used for the diagnosis of MI. If the amount of Troponin T in the blood is elevated, i.e. above 0.1 ng/ml, an acute cardiovascular event is assumed and the patent is treated accordingly. However, it is known that cardiac troponins are also released (in small amounts) in pathological states preceding cell death, e.g. ischemia.

Heart failure is a condition that can result from any structural or functional cardiac disorder that impairs the ability of the heart to fill with or pump a sufficient amount of blood throughout the body. Even with the best therapy, heart failure is associated with an annual mortality of about 10%. Heart failure is a chronic disease; it can, inter alia, occur either following an acute cardiovascular event (like myocardial infarction), or it can occur e.g. as a consequence of inflammatory or degenerative changes in myocardial tissue. Heart failure patients are classified according to the NYHA system in classes I, II, III and IV. A patient having heart failure will not be able to fully restore his health without receiving a therapeutical treatment.

Mycocardial dysfunction is a general term, describing several pathological states of the heart muscle (myocard). A myocardial dysfunction may be a temporary pathological state (caused by e.g. ischemia, toxic substances, alcohol, . . . ), contrary to heart failure. Myocardial dysfunction may disappear after removing the underlying cause. A symptomless myocardial dysfunction may, however, also develop into heart failure (which has to be treated in a therapy). A myocardial dysfunction may, however, also be a heart failure, a chronic heart failure, even a severe chronic heart failure.

Mycocardial dysfunction and heart failure often remain undiagnosed, particularly when the condition is considered “mild”. The conventional diagnostic techniques for heart failure are based on the well-known vascular volume stress marker NT-proBNP. Especially patients which suffer from heart failure would urgently need a supportive therapy of heart failure. On the other hand, as a consequence of an incorrect diagnosis of heart failure, many patients will receive a treatment regimen which is insufficient or which may have even adverse side effects.

In some embodiments, the cardiac function markers of the present disclosure are natriuretic peptides. The term “natriuretic peptide” comprises Atrial Natriuretic Peptide (ANP)-type and Brain Natriuretic Peptide (BNP)-type peptides and variants thereof having the same predictive potential. Natriuretic peptides according to the present disclosure comprise ANP-type and BNP-type peptides and variants thereof (see e.g. Bonow, 1996, Circulation 93: 1946-1950). ANP-type peptides comprise pre-proANP, proANP, NT-proANP, and ANP. BNP-type peptides comprise pre-proBNP, proBNP, NT-proBNP, and BNP. The pre-pro peptide (134 amino acids in the case of pre-proBNP) comprises a short signal peptide, which is enzymatically cleaved off to release the pro peptide (108 amino acids in the case of proBNP). The pro peptide is further cleaved into an N-terminal pro peptide (NT-pro peptide, 76 amino acids in case of NT-proBNP) and the active hormone (32 amino acids in the case of BNP, 28 amino acids in the case of ANP). In some embodiments, natriuretic peptides according to the present disclosure are NT-proANP, ANP, and, in some embodiments, NT-proBNP, BNP, and variants thereof. ANP and BNP are the active hormones and have a shorter half-life than their respective inactive counterparts, NT-proANP and NT-proBNP. BNP is metabolised in the blood, whereas NT-proBNP circulates in the blood as an intact molecule and as such is eliminated renally. The in-vivo half-life of NTproBNP is 120 min longer than that of BNP, which is 20 min (Smith 2000, J Endocrinol. 167: 239-46.). Preanalytics are more robust with NT-proBNP allowing easy transportation of the sample to a central laboratory (Mueller 2004, Clin Chem Lab Med 42: 942-4.). Blood samples can be stored at room temperature for several days or may be mailed or shipped without recovery loss. In contrast, storage of BNP for 48 hours at room temperature or at 4° Celsius leads to a concentration loss of at least 20% (Mueller loc.cit.; Wu 2004, Clin Chem 50: 867-73.). Therefore, depending on the time-course or properties of interest, either measurement of the active or the inactive forms of the natriuretic peptide can be advantageous. In some embodiments, natriuretic peptides according to the present disclosure are NT-proBNP or variants thereof. As briefly discussed above, the human NT-proBNP, as referred to in accordance with the present disclosure, is a polypeptide comprising, for example, 76 amino acids in length corresponding to the N-terminal portion of the human NT-proBNP molecule. The structure of the human BNP and NT-proBNP has been described already in detail in the prior art, e.g., WO 02/089657, WO 02/083913 or Bonow loc. cit. IN some embodiments, human NT-proBNP as used herein is human NT-proBNP as disclosed in EP 0 648 228 B1. These prior art documents are herewith incorporated by reference with respect to the specific sequences of NT-proBNP and variants thereof disclosed therein. The NT-proBNP referred to in accordance with the present disclosure further encompasses allelic and other variants of said specific sequence for human NT-proBNP discussed above. Specifically, envisaged are variant polypeptides which are on the amino acid level suitably, at least 50%, 60%, 70%, 80%, 85%, 90%, 92%, 95%, 97%, 98%, or 99% identical to human NT-proBNP, suitably over the entire length of human NT-proBNP. The degree of identity between two amino acid sequences can be determined by algorithms well known in the art. In some embodiments, the degree of identity is to be determined by comparing two optimally aligned sequences over a comparison window, where the fragment of amino acid sequence in the comparison window may comprise additions or deletions (e.g., gaps or overhangs) as compared to the reference sequence (which does not comprise additions or deletions) for optimal alignment. The percentage is calculated by determining the number of positions at which the identical amino acid residue occurs in both sequences to yield the number of matched positions, dividing the number of matched positions by the total number of positions in the window of comparison and multiplying the result by 100 to yield the percentage of sequence identity. Optimal alignment of sequences for comparison may be conducted by the local homology algorithm of Smith and Waterman Add. APL. Math. 2:482 (1981), by the homology alignment algorithm of Needleman and Wunsch J. Mol. Biol. 48:443 (1970), by the search for similarity method of Pearson and Lipman Proc. Natl. Acad Sci. (USA) 85: 2444 (1988), by computerized implementations of these algorithms (GAP, BESTFIT, BLAST, PASTA, and TFASTA in the Wisconsin Genetics Software Package, Genetics Computer Group (GCG), 575 Science Dr., Madison, Wis.), or by visual inspection. Given that two sequences have been identified for comparison, GAP and BESTFIT are suitably employed to determine their optimal alignment and, thus, the degree of identity. In some embodiments, the default values of 5.00 for gap weight and 0.30 for gap weight length are used. Variants referred to above may be allelic variants or any other species specific homologs, paralogs, or orthologs. Substantially similar and also envisaged are proteolytic degradation products which are still recognized by the diagnostic means or by ligands directed against the respective full-length peptide. Also encompassed are variant polypeptides having amino acid deletions, substitutions, and/or additions compared to the amino acid sequence of human NT-proBNP as long as the said polypeptides have NT-proBNP properties. NT-proBNP properties as referred to herein are immunological and/or biological properties. In some embodiments, the NT-proBNP variants have immunological properties (i.e. epitope composition) comparable to those of humanNT-proBNP. Thus, the variants shall be recognizable by the aforementioned means or ligands used for determination of the amount of the natriuretic peptides. Biological and/or immunological NT-proBNP properties can be detected by the assay described in Karl et al. (Karl 1999, Scand J Clin Lab Invest 230:177-181), Yeo et al. (Yeo 2003, Clinica Chimica Acta 338:107-115). Variants also include post translationally modified peptides such as glycosylated peptides. Further, a variant in accordance with the present disclosure is also a peptide or polypeptide which has been modified after collection of the sample, for example by covalent or non-covalent attachment of a label, particularly a radioactive or fluorescent label, to the peptide.

In some embodiments, the necrosis markers employed in the present disclosure are cardiac troponins. The term “cardiac Troponin” refers to all Troponin isoforms expressed in cells of the heart and, the subendocardial cells. These isoforms are well characterized in the art as described, e.g., in Anderson 1995, Circulation Research, vol. 76, no. 4: 681-686 and Ferrieres 1998, Clinical Chemistry, 44: 487-493. In some embodiments, cardiac Troponin refers to Troponin T and/or Troponin I, and, suitably, to Troponin T. It is to be understood that isoforms of Troponins may be determined in the method of the present disclosure together, i.e. simultaneously or sequentially, or individually, i.e. without determining the other isoform at all. Amino acid sequences for human Troponin T and human Troponin I are disclosed in Anderson, loc cit and Ferrieres 1998, Clinical Chemistry, 44: 487-493.

The term “cardiac Troponin” encompasses also variants of the aforementioned specific Troponins, i.e., in some embodiments, of Troponin I, and in some embodiments, of Troponin T. Such variants have at least the same essential biological and immunological properties as the specific cardiac Troponins. In particular, they share the same essential biological and immunological properties if they are detectable by the same specific assays referred to in this specification, e.g., by ELISA Assays using polyclonal or monoclonal antibodies specifically recognizing the said cardiac Troponins. Moreover, it is to be understood that a variant as referred to in accordance with the present disclosure shall have an amino acid sequence which differs due to at least one amino acid substitution, deletion and/or addition wherein the amino acid sequence of the variant is still, suitably, at least about 50%, at least about 60%, at least about 70%, at least about 80%, at least about 85%, at least about 90%, at least about92%, at least about95%, at least about 97%, at least about 98%, or at least about 99% identical with the amino sequence of the specific Troponin. Variants may be allelic variants or any other species specific homologs, paralogs, or orthologs. Moreover, the variants referred to herein include fragments of the specific cardiac Troponins or the aforementioned types of variants as long as these fragments have the essential immunological and biological properties as referred to above. In some embodiments, the cardiac troponin variants have immunological properties (i.e. epitope composition) comparable to those of human troponin T or troponin I. Thus, the variants shall be recognizable by the aforementioned means or ligands used for determination of the amount of the cardiac troponins. Thus, the variants shall be recognizable by the aforementioned means or ligands used for determination of the amount of the cardiac troponins. Such fragments may be, e.g., degradation products of the Troponins. Further included are variants which differ due to posttranslational modifications such as phosphorylation or myristylation. In some embodiments, the biological property of troponin I and its variant is the ability to inhibit actomyosin ATPase or to inhibit angiogenesis in vivo and in vitro, which may e.g. be detected based on the assay described by Moses et al. 1999 PNAS USA 96 (6): 2645-2650). In some embodiments the biological property of troponin T and its variant is the ability to form a complex with troponin C and I, to bind calcium ions or to bind to tropomyosin, suitably if present as a complex of troponin C, I and T or a complex formed by troponin C, troponin I and a variant of troponin T.

In some embodiments, the amount of a cardiac troponin, such as troponin T, is determined with a sensitive troponin T test system in order to allow a reliable determination of low cardiac troponin amounts, suitably, said test system is capable of determining amounts of 0.002 ng/ml troponin in a sample, for example, in a blood, blood serum or blood plasma sample. In some embodiments, a Troponin T assay in the context of the present disclosure is the Elecsys® 2010 analyzer (Roche Diagnostics) with a detection limit of from about 0.001 ng/ml to about 0.0015 ng/ml, in general about 0.0015 ng/ml.

In some embodiments, the inflammatory marker of the present disclosure is GDF-15 or a variant thereof. The term “Growth-Differentiation Factor-15” or “GDF-15” relates to a polypeptide being a member of the transforming growth factor (TGF)-β cytokine superfamily. The terms polypeptide, peptide and protein are used interchangeable throughout this specification. GDF-15 was originally cloned as macrophage-inhibitory cytokine-1 and later also identified as placental transforming growth factor-β, placental bone morphogenetic protein, non-steroidal anti-inflammatory drug-activated gene-1, and prostate-derived factor (Bootcov loc cit; Hromas, 1997 Biochim Biophys Acta 1354:40-44; Lawton 1997, Gene 203:17-26; Yokoyama-Kobayashi 1997, J Biochem (Tokyo), 122:622-626; Paralkar 1998, J Biol Chem 273:13760-13767). Similar to other TGF-β-related cytokines, GDF-15 is synthesized as an inactive precursor protein, which undergoes disulfide-linked homodimerization. Upon proteolytic cleavage of the N-terminal pro-peptide, GDF-15 is secreted as a -28 kDa dimeric protein (Bauskin 2000, Embo J 19:2212-2220). Amino acid sequences for GDF-15 are disclosed in W099/06445, W000/70051, W02005/113585, Bottner 1999, Gene 237: 105-111, Bootcov loc. cit, Tan loc. cit., Baek 2001, Mol Pharmacol 59: 901-908, Hromas loc cit, Paralkar loc cit, Morrish 1996, Placenta 17:431-441 or Yokoyama-Kobayashi loc cit. GDF-15 as used herein encompasses also variants of the aforementioned specific GDF-15 polypeptides. Such variants have at least the same essential biological and immunological properties as the specific GDF-15 polypeptides. In particular, they share the same essential biological and immunological properties if they are detectable by the same specific assays referred to in this specification, e.g., by ELISA assays using polyclonal or monoclonal antibodies specifically recognizing the said GDF-15 polypeptides. A suitable assay is described in the accompanying Examples. Moreover, it is to be understood that a variant as referred to in accordance with the present disclosure shall have an amino acid sequence which differs due to at least one amino acid substitution, deletion and/or addition wherein the amino acid sequence of the variant is still, in some embodiments, at least about 50%, at least about 60%, at least about 70%, at least about 80%, at least about 85%, at least about 90%, at least about 92%, at least about 95%, at least about 97%, at least about 98%, or at least about 99% identical with the amino sequence of the specific GDF-15 polypeptides, in some embodiments, with the amino acid sequence of human GDF-15, suitably over the entire length of the specific GDF-15, e.g. of human GDF-15. The degree of identity between two amino acid sequences can be determined by algorithms well known in the art. In some embodiments, the degree of identity is to be determined by comparing two optimally aligned sequences over a comparison window, where the fragment of amino acid sequence in the comparison window may comprise additions or deletions (e.g., gaps or overhangs) as compared to the reference sequence (which does not comprise additions or deletions) for optimal alignment. The percentage is calculated by determining the number of positions at which the identical amino acid residue occurs in both sequences to yield the number of matched positions, dividing the number of matched positions by the total number of positions in the window of comparison and multiplying the result by 100 to yield the percentage of sequence identity. Optimal alignment of sequences for comparison may be conducted by the local homology algorithm of Smith and Waterman Add. APL. Math. 2:482 (1981), by the homology alignment algorithm of Needleman and Wunsch J. Mol. Biol. 48:443 (1970), by the search for similarity method of Pearson and Lipman Proc. Natl. Acad Sci. (USA) 85: 2444 (1988), by computerized implementations of these algorithms (GAP, BESTFIT, BLAST, PASTA, and TFASTA in the Wisconsin Genetics Software Package, Genetics Computer Group (GCG), 575 Science Dr., Madison, Wis.), or by visual inspection. Given that two sequences have been identified for comparison, GAP and BESTFIT are employed in some embodiments to determine their optimal alignment and, thus, the degree of identity. In some embodiments, the default values of 5.00 for gap weight and 0.30 for gap weight length are used. Variants referred to above may be allelic variants or any other species specific homologs, paralogs, or orthologs. Moreover, the variants referred to herein include fragments of the specific GDF-15 polypeptides or the aforementioned types of variants as long as these fragments have the essential immunological and biological properties as referred to above. Such fragments may be, e.g., degradation products of the GDF-15 polypeptides. Further included are variants which differ due to posttranslational modifications such as phosphorylation or myristylation.

In some embodiments, the angionesis marker of the present disclosure is PIGF or a variant thereof.

The term “reference amounts” as used herein in this embodiment of the disclosure refers to amounts of the polypeptides which allow allocating the left ventricular hypertrophy as being that of a healthy individual exhibiting physiological hypertrophy or that of a non-healthy individual exhibiting pathological hypertrophy.

Therefore, the reference amounts will in general be derived from a subject known to have physiological left ventricular hypertrophy, in general a subject having an athlete's heart.

The following values are indicative for a healthy individual having physiological left ventricular hypertrophy: Necrosis marker, for example, a cardiac troponin, such as troponin I or troponin T, suitably troponin T referred to herein: at < about 5 pg/ml, suitably≦about 4 pg/ml, suitably≦about 3 pg/ml. Also, the necrosis marker is below the 75^{th} percentile, e.g., below the 95^{th} percentile, of a collective of patients suffering from physiological left ventricular hypertrophy.

Inflammatory marker, such as GDF-15 referred to herein: at ≦about 600 pg/ml, e.g., ≦about 500 pg/ml, suitably ≦about 400 pg/ml. In some embodiments, the inflammatory marker is below the 75^{th} percentile of a collective of individuals having physiological left ventricular hypertrophy.

The following values are indicative for a non-healthy individual having pathological left ventricular hypertrophy: Necrosis marker, such as a cardiac troponin, e.g., troponin I or troponin T, suitably troponin T referred to herein: at > about 5 pg/ml, e.g., > about 8 pg/ml, suitably > about 25 pg/ml. Also, in some embodiments, the necrosis marker is above the median of a collective of patients suffering from pathological left ventricular hypertrophy.

Cardiac function marker, such as a natriuretic peptide, e.g., BNP or NT-proBNP, suitably NT-proBNP as referred to herein: at > about 75 pg/ml, e.g. > about 200 pg/ml, suitably > about 400 pg/ml, suitably > about 800 pg/ml. Also in some embodiments, the cardiac function marker is above the median of a collective of patients suffering from pathological left ventricular hypertrophy.

Inflammatory marker, such as GDF-15 referred to herein: at > about 600 pg/ml, e.g., > about 1000 pg/ml, suitably > about 1500 pg/ml, suitably > about 2000 pg/ml. Also in some embodiments, the inflammatory marker is above the median of a collective of patients suffering from pathological left ventricular hypertrophy.

The above-referenced values, suitably, are those for serum samples.

The term “about” as used herein refers to +/−20%, suitably +/−10%, suitably, +/−5% of a given measurement or value.

In some embodiments of the present disclosure, the amounts/levels of the respective markers used therein (cardiac function markers, suitably a natriuretic peptide, suitably NT-proBNP; necrosis markers, suitably a cardiac troponin, suitably troponin T; and inflammatory markers, suitably GDF-15; and, in some embodiments, PIGF) indicating if an individual has physiological left ventricular hypertrophy or suffers from pathological left ventricular hypertrophy or is an healthy individual, are determined by methods known to the person skilled in the art.

In general, for determining the respective amounts/levels or amount ratios allowing to establish the desired diagnosis in accordance with the respective embodiment of the present disclosure, (“threshold”, “reference amount”), the amount(s)/level(s) or amount ratios of the respective peptide or peptides are determined in appropriate patient groups. According to the diagnosis to be established, the patient group may, for example, comprise only healthy individuals, or may comprise healthy individuals and individuals suffering from the pathopysiological state which is to be determined, or may comprise only individuals suffering from the pathopysiological state which is to be determined, or may comprise individuals suffering from the various pathophysiological states to be distinguished, by the respective marker(s) using validated analytical methods. The results which are obtained are collected and analyzed by statistical methods known to the person skilled in the art. The obtained threshold values are then established in accordance with the desired probability of suffering from the disease and linked to the particular threshold value. For example, it may be useful to choose the median value, the 60^{th, 70th}_{,}^{80th}_{,}^{90th,} 95^{th} or even the 99^{th} percentile of the healthy and/or non-healthy patient collective, in order to establish the threshold value(s), reference value(s) or amount ratios.

A reference value of a diagnostic marker can be established, and the level of the marker in a patient sample can simply be compared to the reference value. The sensitivity and specificity of a diagnostic and/or prognostic test depends on more than just the analytical “quality” of the test-they also depend on the definition of what constitutes an abnormal result. In practice, Receiver Operating Characteristic curves, or “ROC” curves, are typically calculated by plotting the value of a variable versus its relative frequency in “normal” and “disease” populations. For any particular marker of the disclosure, a distribution of marker levels for subjects with and without a disease will likely overlap. Under such conditions, a test does not absolutely distinguish normal from disease with 100% accuracy, and the area of overlap indicates where the test cannot distinguish normal from disease. A threshold is selected, above which (or below which, depending on how a marker changes with the disease) the test is considered to be abnormal and below which the test is considered to be normal. The area under the ROC curve is a measure of the probability that the perceived measurement will allow correct identification of a condition. ROC curves can be used even when test results don't necessarily give an accurate number. As long as one can rank results, one can create an ROC curve. For example, results of a test on “disease” samples might be ranked according to degree (say 1=low, 2=normal, and 3=high). This ranking can be correlated to results in the “normal” population, and a ROC curve created. These methods are well known in the art. See, e.g., Hanley et al, Radiology 143: 29-36 (1982).

In certain embodiments, markers and/or marker panels are selected to exhibit at least about 70% sensitivity, suitably at least about 80% sensitivity, suitably at least about 85% sensitivity, suitably at least about 90% sensitivity, and suitably at least about 95% sensitivity, combined with at least about 70% specificity, suitably at least about 80% specificity, suitably at least about 85% specificity, suitably at least about 90% specificity, and suitably at least about 95% specificity. In some embodiments, both the sensitivity and specificity are at least about 75%, suitably at least about 80%, suitably at least about 85%, suitably at least about 90%, and suitably at least about 95%. The term “about” in this context refers to +/−5% of a given measurement.

In other embodiments, a positive likelihood ratio, negative likelihood ratio, odds ratio, or hazard ratio is used as a measure of a test's ability to predict risk or diagnose a disease. In the case of a positive likelihood ratio, a value of 1 indicates that a positive result is equally likely among subjects in both the “diseased” and “control” groups; a value greater than 1 indicates that a positive result is more likely in the diseased group; and a value less than 1 indicates that a positive result is more likely in the control group. In the case of a negative likelihood ratio, a value of 1 indicates that a negative result is equally likely among subjects in both the “diseased” and “control” groups; a value greater than 1 indicates that a negative result is more likely in the test group; and a value less than 1 indicates that a negative result is more likely in the control group. In certain embodiments, markers and/or marker panels are selected to exhibit a positive or negative likelihood ratio of at least about 1.5 or more or about 0.67 or less, at least about 2 or more or about 0.5 or less, at least about 5 or more or about 0.2 or less, at least about 10 or more or about 0.1 or less, and in some embodiments, at least about 20 or more or about 0.05 or less. The term “about” in this context refers to +/−5% of a given measurement.

In the case of an odds ratio, a value of 1 indicates that a positive result is equally likely among subjects in both the “diseased” and “control” groups; a value greater than 1 indicates that a positive result is more likely in the diseased group; and a value less than 1 indicates that a positive result is more likely in the control group. In certain embodiments, markers and/or marker panels are selected to exhibit an odds ratio of at least about 2 or more or about 0.5 or less, for example, at least about 3 or more or about 0.33 or less, suitably at least about 4 or more or about 0.25 or less, suitably at least about 5 or more or about 0.2 or less, and suitably at least about 10 or more or about 0.1 or less. The term “about” in this context refers to +/−5% of a given measurement.

In the case of a hazard ratio, a value of 1 indicates that the relative risk of an endpoint (e.g., death) is equal in both the “diseased” and “control” groups; a value greater than 1 indicates that the risk is greater in the diseased group; and a value less than 1 indicates that the risk is greater in the control group. In certain embodiments, markers and/or marker panels are selected to exhibit a hazard ratio of at least about 1.1 or more or about 0.91 or less, in some embodiments, at least about 1.25 or more or about 0.8 or less, in some embodiments, at least about 1.5 or more or about 0.67 or less, in some embodiments at least about 2 or more or about 0.5 or less, and in some embodiments at least about 2.5 or more or about 0.4 or less. The term “about” in this context refers to +/−5% of a given measurement.

While exemplary panels are described herein, one or more markers may be replaced, added, or subtracted from these exemplary panels while still providing clinically useful results. Panels may comprise both specific markers of a disease (e.g., markers that are increased or decreased in bacterial infection, but not in other disease states) and/or non-specific markers (e.g., markers that are increased or decreased due to inflammation, regardless of the cause; markers that are increased or decreased due to changes in hemostasis, regardless of the cause, etc.). While certain markers may not individually be definitive in the methods described herein, a particular “fingerprint” pattern of changes may, in effect, act as a specific indicator of disease state. As discussed above, that pattern of changes may be obtained from a single sample, or may optionally consider temporal changes in one or more members of the panel (or temporal changes in a panel response value).

In order to test if a chosen reference value yields a sufficiently safe diagnosis of patients suffering from the disease of interest, one may for example determine the efficiency (E) of the methods of the disclosure for a given reference value using the following formula: E=(TP/TO)×100, wherein TP=true positives and TO=total number of tests=TP+FP+FN+TN, wherein FP=false positives; FN=false negatives and TN=true negatives. E has the following range of values: 0<E<100). In some embodiments, a tested reference value yields a sufficiently safe diagnosis provided the value of E is at least about 50, suitably at least about 60, suitably at least about 70, suitably at least about 80, suitably at least about 90, suitably at least about 95, suitably at least about 98.

The diagnosis if individuals are healthy or suffer from a certain pathophysiological state is made by established methods known to the person skilled in the art. The methods differ in respect to the individual pathophysiological state.

The algorithms to establish the desired diagnosis are laid out in the present application, in the passages referring to the respective embodiment, to which reference is made.

Accordingly, the present disclosure also comprises a method of determining the threshold level indicative for a physiological and/or a pathological state and/or a certain pathological state, comprising the steps of determining in appropriate patient groups the levels of the appropriate marker(s), collecting the data and analyzing the data by statistical methods and establishing the threshold values.

In the present disclosure, the appropriate markers are cardiac function markers, in some embodiments, a natriuretic peptide, for example NT-proBNP; necrosis markers, suitably a cardiac troponin, for example troponin T; and inflammatory markers, suitably GDF-15; and, in some embodiments, PIGF. The individuals/subjects may comprise healthy individuals having physiological left ventricular hypertrophy; and/or individuals having pathological left ventricular hypertrophy; and/or individuals having obstructive left ventricular cardiomyopathy, non-obstructive left ventricular cardiomyopathy, hypertensive left ventricular hypertrophy, and/or hypertrophy associated with aortic stenosis (both latter forms being referred to as “pressure overload hypertrophy” in the present application.

For all above-cited markers (troponin I or troponin T, BNP or NT-proBNP, GDF-15) the lowest values correspond to a physiological state in an absolutely healthy individual, whereas higher values may correspond to a physiological state in an individual which may have a slight health impairment, but which is still considered as being an healthy individual; still higher values are characteristic for a non-healthy individual suffering from pathological hypertrophy.

Moreover, the reference amounts, in some embodiments, define thresholds. Suitable reference amounts or threshold amounts may be determined by the method of the present disclosure from a reference sample to be analyzed together, i.e. simultaneously or subsequently, with the test sample.

The person skilled in the art is aware that the values cited beforehand for the cardiac troponins (troponin T and troponin I), for the natriuretic peptides, in particular NT-proBNP, and—to a lesser extent—for GDF-15 may not apply for patients suffering from impaired renal function, in some embodiments, patients suffering from renal failure, in particular patients suffering from chronic and end stage renal failure. In one embodiment of the present disclosure, patients suffering from impaired renal function, in some embodiments, patients suffering from renal failure, in particular patients suffering from chronic and end stage renal failure are not comprised in (excluded from) the methods of the present disclosure. In another embodiment, patients with renal hypertension are not comprised in (excluded from) the methods of the present disclosure. In some embodiments, the “subject having left ventricular hypertrophy” as used herein excludes patients suffering from impaired renal function, in some embodiments patients suffering from renal failure, in particular patients suffering from chronic and end stage renal failure, in some embodiments patients with renal hypertension, in some embodiments all of the patients suffering from one of the diseases and conditions mentioned in this sentence. In this context, “renal failure” is regarded as an impaired glomerular filtration rate (GFR) lying below the usual ranges of 60 to 120 ml/min, in some embodiments below 60 ml/min. Chronic renal failure is a long-standing, progressive deterioration of renal function which often results in end stage renal failure. End stage renal failure is diagnosed when the GFR reaches a rate of up to about 30 ml/min. GFR is determined by the creatinine clearance, which is known to the person skilled in the art. Subjects with impaired renal function show higher levels of troponin I and troponin T than those cited above, due to an impaired clearance of the peptide. The levels vary with the severity of the renal impairment.

The severity of renal impairment is divided into various grades, as displayed below:

0:≧90 ml/min

1:≧90 ml/min with microalbuminuria

2:≧60−<90 ml/min

3:≧30−<60 ml/min

4:≧15−<30 ml/min

5:<15 ml/min

(Source: National Kidney Foundation, as published in: Am J. Kidney Dis 39 suppl 1, 2002; Clinical Practice Guidelines for chronic kidney disease)

The present disclosure also encompasses a method which allows to distinguish (diagnose), in a subject suffering from pathological left ventricular hypertrophy, if the subject suffers from hypertrophic non-obstructive cardiomyopathy, hypertrophic obstructive cardiomyopathy or pressure overload hypertrophy, comprising the steps of:
A) determining the amounts of at least one marker selected from cardiac function markers, at least one markers selected from necrosis markers, and at least one marker selected from inflammatory markers, in at least one sample of said subject,
B) comparing the amounts to reference amounts, and
C) distinguishing between hypertrophic non-obstructive cardiomyopathy, hypertrophic obstructive cardiomyopathy and pressure overload hypertrophy, depending on the results of step b).

The present disclosure also relates to the use of at least one marker selected from necrosis markers, at least one marker selected from cardiac function markers and at least one marker selected from inflammatory markers for diagnosing or distinguishing, in a subject suffering from pathological left ventricular hypertrophy, if the subject suffers from hypertrophic non-obstructive cardiomyopathy, hypertrophic obstructive cardiomyopathy or pathological hypertensive left ventricular hypertrophy.

In some embodiments the cardiac function marker is a BNP-type marker or a variant thereof, in some embodiments NTproBNP or a variant thereof. In some embodiments, the necrosis marker is Troponin T or a variant thereof. In some embodiments, the inflammatory marker is GDF-15 or a variant thereof. In one embodiment of the above method, the amounts of NTproBNP or a variant thereof, Troponin T or a variant thereof, and GDF-15 or a variant thereof are determined. In some embodiments of this method of the present disclosure, the ratio of 2 markers in formed.

In one further embodiment of the present disclosure, allowing to distinguish between the various forms of pathological left ventricular hypertrophy as laid out beforehand, the amount of PIGF is determined in a sample of the subject. In case the subject displays an amount of PIGF which is at least about 12.4 pg/ml, preferably at least about 15.0 pg/ml, in particular at least about 16.7 pg/ml, the amount is indicative that the subject suffers from obstructive left ventricular hypertrophy. Also in some embodiments, the reference amount is the 50^{th} or 75^{th} percentile of a collective of patients suffering from obstructive left ventricular hypertrophy.

In one embodiment of the present disclosure, the ratio between the natriuretic peptide, in some embodiments, NT-proBNP, and the inflammatory marker, suitably GDF-15, is formed. From this ratio, it is possible to distinguish if the pathological state the subject suffers from is hypertrophic non-obstructive cardiomyopathy, on the one hand, or selected from hypertrophic obstructive cardiomyopathy and pressure overload hypertrophy, on the other hand. Whereas the ratios NT-proBNP/GDF-15 in hypertrophic obstructive cardiomyopathy and pressure overload hypertrophy are to close to allow a differentiation between the two states in a subject, the ratio is higher in patients suffering from hypertrophic non-obstructive cardiomyopathy when compared to the respective ratios of NT-proBNP/GDF-15 in hypertrophic obstructive cardiomyopathy and pressure overload hypertrophy patients.

Accordingly, the present disclosure provides a method for diagnosing (distinguishing), in a subject suffering from pathological left ventricular hypertrophy, if the subject suffers from hypertrophic non-obstructive cardiomyopathy, on the one hand, or from a cardiomyopathy selected from hypertrophic obstructive cardiomyopathy and pressure overload hypertrophy, on the other hand, comprising the steps of:
a) determining the amounts of at least one marker selected from cardiac function markers and at least one marker selected from inflammatory markers, in at least one sample of said subject;
b) forming the ratio between a cardiac function marker and an inflammatory marker;
c) comparing the amounts to reference amounts; and
d)distinguishing between the hypertrophic non-obstructive cardiomyopathy, on the one hand, or from a cardiomyopathy selected from hypertrophic obstructive cardiomyopathy and pressure overload hypertrophy, on the other hand, depending on the results of step c).

The above described method for diagnosing (distinguishing), in a subject suffering from pathological left ventricular hypertrophy, if the subject suffers from hypertrophic non-obstructive cardiomyopathy, on the one hand, or from a cardiomyopathy selected from hypertrophic obstructive cardiomyopathy and pressure overload hypertrophy, on the other hand, may also comprise the steps of:
a) determining the amounts of at least one marker selected from cardiac function markers and at least one marker selected from inflammatory markers, in at least one sample of said subject;
b) forming the ratio between a cardiac function marker and an inflammatory marker;
c) distinguishing between hypertrophic non-obstructive cardiomyopathy, on the one hand, or from a cardiomyopathy selected from hypertrophic obstructive cardiomyopathy and pressure overload hypertrophy, by comparing the amounts to reference amounts on the other hand.

The above step of distinguishing, may be based on the results of said comparison and depends from the results obtained.

The present disclosure, thus, relates to a method for diagnosing (distinguishing), in a subject suffering from pathological left ventricular hypertrophy, if the subject suffers from hypertrophic non-obstructive cardiomyopathy, on the one hand, or from a cardiomyopathy selected from hypertrophic obstructive cardiomyopathy and pressure overload hypertrophy, on the other hand based on the determination of the amounts of at least one marker selected from cardiac function markers and at least one marker selected from inflammatory markers, in at least one sample of said subject, the calculation of a ratio between a cardiac function marker and an inflammatory marker and the comparison of the determined amounts to reference amounts.

In one embodiment of the present disclosure, the reference amount is a ratio of a cardiac function marker and an inflammatory marker that has been determined in a patient or a group of patients suffering from obstructive cardiomyopathy. Or the reference amount may be the ratio of a cardiac function marker and an inflammatory marker that has been determined in a patient or a group of patients suffering from hypertrophic obstructive cardiomyopathy or pressure overload hypertrophy.

The present disclosure also relates to the use of at least one marker selected from cardiac function markers and at least one marker selected from inflammatory markers for the preparation of a diagnostic for distinguishing, in a subject suffering from pathological left ventricular hypertrophy, if the subject suffers from hypertrophic non-obstructive cardiomyopathy, on the one hand, or from a cardiomyopathy selected from hypertrophic obstructive cardiomyopathy and pathological hypertensive left ventricular hypertrophy, on the other hand.

In one embodiment, the cardiac function marker is a natriuretic peptide, suitably BNP or NT-proBNP, suitably NT-proBNP; suitably, the inflammatory marker is GDF-15.

NT-proBNP/GDF-15 values indicative for the occurrence of hypertrophic non-obstructive cardiomyopathy are values ≧ (higher than or equal to) about 0.43, suitably ≧ about 0.6, suitably about ≧0.8.

NT-proBNP/GDF-15 values indicative for the occurrence of hypertrophic obstructive cardiomyopathy and pressure overload hypertrophy are values < (lower than) about 0.43, suitably < about 0.3, suitably < about 0.2.

In one further embodiment of the present disclosure, allowing to distinguish between the various forms of pathological left ventricular hypertrophy as laid out beforehand, the amount of PIGF is determined in a sample of the subject. In case the subject displays an amount of PIGF which is at least about 12.4 pg/ml, suitably at least about 15.0 pg/ml, suitably at least about 16.7 pg/ml, the amount is indicative that the subject suffers from in particular obstructive left ventricular hypertrophy as a subject suffering thereof shows the highest amounts of this peptide, in general around 15 pg/ml. Therefore, the reference amount is, also suitably, the 50^{th} or 75^{th} percentile of a collective of patients suffering from obstructive left ventricular hypertrophy.

In a further embodiment of the present disclosure, the ratio between the necrosis marker, such as troponin I or troponin T, suitably troponin T, and the inflammatory marker, suitably GDF-15, is formed. From this ratio, it is possible to distinguish if the pathological state the subject suffers from is hypertrophic obstructive cardiomyopathy, hypertrophic non-obstructive cardiomyopathy or pressure overload hypertrophy.

Accordingly, the present disclosure provides a method for diagnosing (distinguishing) in a subject suffering from pathological left ventricular hypertrophy, if the subject suffers from hypertrophic non-obstructive cardiomyopathy, hypertrophic obstructive cardiomyopathy or pressure overload hypertrophy, comprising the steps of:
a) determining the amounts of at least one marker selected from necrosis markers and at least one marker selected from inflammatory markers, in at least one sample of said subject,
b) forming the ratio between the necrosis marker and an inflammatory marker,
c) comparing the amounts to reference amounts, and
d) distinguishing between hypertrophic non-obstructive cardiomyopathy, hypertrophic obstructive cardiomyopathy and pressure overload hypertrophy, depending on the results of step c).

The above described method for diagnosing (distinguishing) in a subject suffering from pathological left ventricular hypertrophy, if the subject suffers from hypertrophic non-obstructive cardiomyopathy, hypertrophic obstructive cardiomyopathy or pressure overload hypertrophy, may also comprise the steps of
a) determining the amounts of at least one marker selected from necrosis markers and at least one marker selected from inflammatory markers, in at least one sample of said subject,
b) forming the ratio between the necrosis marker and an inflammatory marker,
c) distinguishing between hypertrophic non-obstructive cardiomyopathy, hypertrophic obstructive cardiomyopathy and pressure overload hypertrophy, by comparing the amounts to reference amounts.

The above step of distinguishing, in some embodiments, is based on the results of said comparison and depends from the results obtained.

The present disclosure, thus, relates to a method for diagnosing (distinguishing), in a subject suffering from pathological left ventricular hypertrophy, if the subject suffers from hypertrophic non-obstructive cardiomyopathy, hypertrophic obstructive cardiomyopathy or pressure overload hypertrophy based on the determination of the amounts of at least one marker selected from necrosis markers and at least one marker selected from inflammatory markers, in at least one sample of said subject, the calculation of a ratio between the necrosis marker and the inflammatory marker and the comparison of the determined amounts to reference amounts.

In one embodiment of the present disclosure, the reference amount is a ratio of a necrosis marker and an inflammatory marker that has been determined in a patient or a group of patients suffering from hypertrophic non-obstructive cardiomyopathy. Or the reference amount may be the ratio of a cardiac function marker and an inflammatory marker that has been determined in a patient or a group of patients suffering from hypertrophic obstructive cardiomyopathy. Or the reference amount may be the ratio of a cardiac function marker and an inflammatory marker that has been determined in a patient or a group of patients suffering from pressure overload hypertrophy.

The present disclosure also relates to the use of at least one marker selected from necrosis markers and at least one marker selected from inflammatory markers for the preparation of a diagnostic for distinguishing, in a subject suffering from pathological left ventricular hypertrophy, if the subject suffers from hypertrophic non-obstructive cardiomyopathy, hypertrophic obstructive cardiomyopathy or pathological hypertensive left ventricular hypertrophy.

In one embodiment, the necrosis marker is selected from troponin T and troponin I, in particular the necrosis marker is troponin T; suitably, the inflammatory marker is GDF-15.

Troponin T/GDF-15 values indicative for the occurrence of hypertrophic non-obstructive cardiomyopathy are values ≧ (higher than or equal to) about 0.01, suitably ≧ about 0.03, in particular ≧ about 0.06.

Troponin T/GDF-15 values indicative for the occurrence of hypertrophic obstructive cardiomyopathy are values≦(lower than or equal to) about 0.004, suitably≦about 0.002, suitably≦about 0.001.

Troponin T/GDF-15 values indicative for the occurrence of pressure overload hypertrophy are values ranging from > about 0.004 to < about 0.01, suitably about 0.006, suitably about 0.008.

In one further embodiment of the present disclosure, allowing to distinguish between the various forms of pathological left ventricular hypertrophy as laid out beforehand, the amount of PIGF is determined in a sample of the subject. By this, it is possible to recognize in particular obstructive left ventricular hypertrophy as a subject suffering thereof shows the high amounts of this peptide.

Accordingly, the present disclosure furthermore comprises a method of diagnosing hypertrophic obstructive cardiomyopathy in an individual, the method comprising determining the amount of PIGF in a sample of the subject, wherein an elevated amount of PIGF is indicative for hypertrophic obstructive cardiomyopathy.

PIGF values indicative for the occurrence of obstructive left ventricular hypertrophy are values ≧ (higher than or equal to) about 12.4 pg/ml, suitably ≧ about 15.0 pg/ml, in particular ≧ about 16.7 pg/ml. Also in some embodiments, the reference amount is the 50^{th} or 75^{th} percentile of a collective of patients suffering from obstructive left ventricular hypertrophy.

The term “diagnosing” as used herein means assessing, identifying, evaluating or classifying if a subject has hypertrophic non-obstructive cardiomyopathy, hypertrophic obstructive cardiomyopathy and/or pressure overload hypertrophy (i.e. pathological hypertensive left ventricular hypertrophy or hypertrophy associated with aortic stenosis), according to the respective embodiment of the present disclosure. The term “diagnosing” also refers to distinguishing between the above-cited forms of pathological left ventricular hypertrophy, according to the respective embodiment of the present disclosure.

The person skilled in the art is aware of methods to diagnose if the subject suffers from physiological or pathological left ventricular hypertrophy. In a subject which is known to have left ventricular hypertrophy, distinguishing between pathological and physiological and, in a subject known to suffer from pathological left ventricular hypertrophy, and distinguishing between the various forms of left ventricular hypertrophy is in general costly, time-consuming and requires medical skill and experience. Methods of evaluation are known to the person skilled in the art and are typically based on medical history, obvious signs of a cardiac dysfunction (e.g. fatigue, fainting (syncope), chest pain, shortness of breath, awareness of irregular heartbeats (palpitations) produced by an abnormal heart rhythm (arrhythmia)), examination of vital body functions (e.g. blood pressure). Further evaluation includes examination using diagnostic apparatusses/devices (cardiac auscultation (stethoscopy), ECG, echocardiography, chest x-ray, radionuclide imaging, ventriculography, CT scan, MRI and/or stress testing, coronary angiography, ultrasonography). Some patients require transvenous endomyocardial biopsy. Other tests may be done as needed to determine the cause. Treatment depends on the specific type and cause of cardiomyopathy.

In general, a subject is diagnosed (e.g. by echocardiography) for left ventricular hypertrophy, if the subject's medical history indicates a certain probability, or in the course of a routine examination, or a combination of both. Prior to the diagnosis, the occurrence of LVH is often suspected, due to hints in the ECG. For example, the subject may be a competitive endurance athlete with a probability for the occurrence of left ventricular hypertrophy; or the individual may have a family history of hypertrophic cardiomyopathy or cases of sudden cardiac death.

It is then evaluated if the left ventricular hypertrophy is physiological or pathological and, as the case may be, which form of pathological left ventricular hypertrophy is present. This evaluation/diagnosis may include various examinations, diagnostic conclusions and exclusions, as laid out hereinafter.

In case of LVH in a competitive athlete, it may be diagnosed if the LVH is physiological or pathological (in particular if the subject has a family history of hypertrophic cardiomyopathy or of sudden cardiac death) by a genetic examination; the genetic examination shows if there is a family history physiological or the pathological form is present and which form can be excluded. In case a left ventricular hypertrophy is diagnosed in a subject other than in a competitive athlete, left ventricular hypertrophy is pathological and the physiological form can be excluded. In case the subject has a history of hypertension, and the hypertension still persists, the subject suffers from hypertensive LVH; accordingly other forms can generally be excluded. Aortic stenosis can be diagnosed by cardiac auscultation, and determination of the left ventricular outflow gradient; aortic stenosis is often confirmed by echocardiography; this way, the other forms of pathological LVH including hypertensive LVH can be ruled out. Hypertrophic cardiomyopathy can be diagnosed by genetic examination, often after exclusion of the other forms of pathological LVH. In individuals suffering from hypertrophic cardiomyopathy, obstruction can be diagnosed by determining the left ventricular outflow gradient.

To further illustrate the disclosure, a subject is for example diagnosed as having cardiac hypertrophy. In such a subject, hypertensive left ventricular hypertrophy is diagnosed by measuring blood pressure and/or referring to medical history. Hypertrophic cardiomyopathy can be diagnosed by exclusion of other forms of hypertrophy (as hypertensive left ventricular hypertrophy) and/or by genetic examination. A known risk factor is a family history of hypertrophic cardiomyopathy or of unexplained sudden death. In patients diagnosed with hypertrophic cardiomyopathy, obstructive hypertrophic cardiomyopathy can be diagnosed by measuring the outflow gradient.

The diagnostic methods listed above can be used supplementary/complementary with the methods of the present disclosure based on the determination of the cited markers (at least one necrosis marker, at least one cardiac function marker and at least one inflammatory marker; suitably the cardiac function marker being a natriuretic peptide, such as a BNP-type natriuretic peptide or a variant thereof, for example NTproBNP or a variant thereof; suitably, the necrosis marker being a cardiac troponin, such as troponin T or a variant thereof; suitably, the inflammatory marker being GDF-15 or a variant thereof; in one embodiment of the above method, the amounts of NTproBNP or a variant thereof, Troponin T or a variant thereof, and GDF-15 or a variant thereof are determined; additionally, PIGF is determined, in one embodiment of the disclosure).

For example, it may immediately be distinguished between physiological and pathological individuals by determining the amounts of the markers of the present disclosure. A further example includes forming the ratio between a cardiac function marker and an inflammatory marker and diagnosing if the subject suffers from hypertrophic non-obstructive cardiomyopathy, on the one hand, or from a cardiomyopathy selected from hypertrophic obstructive cardiomyopathy and pressure overload hypertrophy, on the other hand. If the subject does not suffer from non-obstructive hypertrophic cardiomyopathy, it can be excluded and the differentiation between the remaining states of LVH can be made by one or more of the methods laid out above (or, alternatively, by further embodiments of the present disclosure).

These supplementary/complementary methods, accordingly, are embodiments of the present disclosure.

In a further embodiment of the present disclosure, the supplementary/complementary methods as laid out beforehand can be used for the methods of deciding on the treatment of a subject as referred to above, based on the aforementioned steps. These methods are laid out hereinafter and allow to decide which pharmaceutical or pharmaceuticals should be taken by said subject or which other therapy the subject should undergo.

The markers (peptides) which are used in the present disclosure can also be used, in further embodiments of the present disclosure, for the confirmation of a diagnosis established by a conventional diagnostic method known in the art. Accordingly, the present disclosure also relates to a method of confirming a diagnosis which is not or only partly-based on the determination of the markers used in the present disclosure, by determining the amounts of the markers used in the present disclosure, comparing these to reference amounts, and confirming or not confirming the diagnosis obtained by methods according to the state of the art.

Angiogenesis is known as the formation of new blood vessels from already existing blood vessels by a capillary sprouting process. The process is under physiological conditions essentially driven by angiogenic growth factors such as the vascular endothelial growth factor (VEGF). The expression of such angiogenic growth factors is regulated pivotally by hypoxia. Thus, if a tissue becomes ischemic, the cells will start to produce angiogenic growth factors which will attract new blood vessels to the tissue by angiogenesis.

However, the capability of a subject for angiogenesis, i.e. its angiogenic status, is dependent on complex biological parameters. Various angiogenesis promoting factors as well as inhibitors of angiogenesis have been reported (Nyberg 2005, Cancer Res 65:3967-3979).

Angiogenesis is observed during tumor growth where the growing tumor becomes more and more affected by hypoxia.

Other disease conditions which are accompanied by hypoxia and ischemia include the coronary artery diseases. Said diseases are characterized by stenosis or occlusion of vessels of the coronary artery system, e.g. by atherosclerosis or thromboembolic occlusions. Coronary artery diseases result in ischemia of the myocardium. Said ischemia, if left untreated, may severely interfere with the physiological function of the heart and result in cardiac disorders including heart failure or even myocardial infarction. For patients suffering from coronary artery diseases, an angiogenic therapy may assist in avoiding the aforementioned life-threatening conditions. Moreover, angiogenic therapies may even help to circumvent complicated cardiac interventions such as stent implantation or bypass surgery.

As set forth above already, various factors besides VEGF have been reported to play a role in angiogenesis. Placental growth factor (PIGF) is a closely related growth factor suggested to play a role in the related process of arteriogenesis together with its putative receptor Flt-1 (Khurana 2005, Circulation 111:2828-2836). Other factors which are possibly involved in arteriogenesis and angiogenesis are the members of the Transforming growth factor-beta superfamily as well as their receptors or binding partners such as the ALK receptors or Endoglin (van Laake 2006, Circulation, 114:2288-2297; Bobik 2006, Arterioscler Thromb Vasc Biol 26: 1712-1720; Bertolino 2005, Chest Supplement 128: 585-590). Fibroblast growth factor (FGF), Platlet derived growth factor (PDGF) as well as cytokines and matrix-metalloproteinases have been also described as potent angiogenic factors (Nyberg, loc.cit.).

The term “PIGF (Placental Growth Factor)” as used herein refers to a placenta derived growth factor which is a 149-amino-acid-long polypeptide and is highly homologous (53% identity) to the platelet-derived growth factor-like region of human vascular endothelial growth factor (VEGF). Like VEGF, PIGF has angiogenic activity in vitro and in vivo. For example, biochemical and functional characterization of PIGF derived from transfected COS-1 cells revealed that it is a glycosylated dimeric secreted protein able to stimulate endothelial cell growth in vitro (Maglione1993, Oncogene 8(4):925-31). In some embodiments, PIGF refers to human PIGF, for example, to human PIGF having an amino acid sequence as shown in Genebank accession number P49763, GI: 17380553 (Genebank is available from the NCBI, USA, e.g. under www.ncbi.nlm.nih.gov/entrez). Moreover, it is to be understood that a variant as referred to in accordance with the present disclosure shall have an amino acid sequence which differs due to at least one amino acid substitution, deletion and/or addition wherein the amino acid sequence of the variant is still, in some embodiments, at least about 50%, at least about 60%, at least about 70%, at least about 80%, at least about 85%, at least about 90%, at least about 92%, at least about 95%, at least about 97%, at least about 98%, or at least about 99% identical with the amino sequence of the specific PIGF, suitably with the amino acid sequence of human PIGF, suitably identical with the amino sequence of human PIGF over the entire length of human PIGF. Variants may be allelic variants, splice variants or any other species specific homologs, paralogs, or orthologs. Moreover, the variants referred to herein include fragments of the specific PIGF or the aforementioned types of variants as long as these fragments have the essential immunological and biological properties as referred to above. Such fragments may be, e.g., degradation products of PIGF. Further included are variants which differ due to posttranslational modifications such as phosphorylation or myristylation.

Also, in accordance with the present disclosure, and with respect to the reference values cited beforehand, an increased amount of cardiac troponin, in particular troponin T is indicative for myocardial ischemia and hypoxia and/or necrosis, in particular necrosis whereas with respect to the reference values, a decreased amount of cardiac troponin, in particular troponin T is indicative for the absence of myocardial ischemia and hypoxia and/or necrosis, in particular necrosis. Thus, in one embodiment of the method of the present disclosure, an increased amount of cardiac troponin, in particular troponin T is indicative for myocardial ischemia and hypoxia and/or necrosis, in particular necrosis. In another embodiment of the method of the present disclosure, a decreased amount of cardiac troponin, in particular troponin T is indicative for myocardial ischemia and hypoxia and/or necrosis, in particular necrosis.

Furthermore, in accordance with an embodiment of the present disclosure, and with respect to the above-cited reference values, an increased amount of natriuretic peptide, in particular NT-proBNP is indicative for myocardial dysfunction, in particular heart failure, whereas with respect to the reference values, a decreased amount of natriuretic peptide, in particular NT-proBNP is indicative for the absence of myocardial dysfunction, in particular for the absence of heart failure. Thus, in one embodiment of the method of the present disclosure, an increased amount of natriuretic peptide, such as NT-proBNP is indicative for myocardial dysfunction, e.g., heart failure. In another embodiment of the method of the present disclosure, a decreased amount of natriuretic peptide, such as NT-proBNP is indicative for the absence of myocardial dysfunction, such as for the absence of heart failure.

In general, before the method of the present disclosure to distinguish between pathological and physiological left ventricular hypertrophy is carried out, left ventricular hypertrophy is diagnosed by the methods known to the person skilled in the art, in general stethoscopy and/or ECG and/or chest x-ray and/or echocardiography. In one embodiment these additional diagnostic steps are part of the present disclosure. This may also apply for the other methods of the present disclosure which relate to distinguishing between different forms of left ventricular hypertrophy, methods of therapy decisions and monitoring.

The person skilled in the art is aware of methods to distinguish between the various forms of pathological hypertrophy cited beforehand. In a subject which is known to have pathological left ventricular hypertrophy, the differentiation between the various forms is in general costly, time-consuming and requires medical skill and experience. Further to the methods cited above, a diagnosis is established on the basis of medical history, obvious signs of a cardiac dysfunction (e.g. fatigue, fainting (syncope), chest pain, shortness of breath, awareness of irregular heartbeats (palpitations) produced by an abnormal heart rhythm (arrhythmia)) and examination of vital body functions (e.g. blood pressure).

The present inventors found that based on the measurement of the amount of the at least one marker in the sample from a subject it was possible to distinguish, in a subject suffering from pathological left ventricular hypertrophy, between the various forms thereof (i.e. hypertrophic non-obstructive cardiomyopathy, hypertrophic obstructive cardiomyopathy or pressure overload hypertrophy), as it is e.g. evident from the examples.

Left ventricular hypertrophy and hypertrophic cardiomyopathy can be accompanied by more or less severe forms of myocardial dysfunction, left ventricular dysfunction or heart failure. Both terms are known to the person skilled in the art.

The present disclosure therefore also relates to cardiac disorders, such as from the group myocardial dysfunction, left ventricular dysfunction and heart failure.

The term “myocardial dysfunction” as used herein is a general term and relates to several pathological states of the myocard. A myocardial dysfunction may be a temporary pathological state (caused by e.g. ischemia, toxic substances, alcohol, . . . ). Myocardial dysfunction may disappear after removing the underlying cause. In the context of the present disclosure, the myocardial dysfunction can be a symptomless myocardial dysfunction. A myocardial dysfunction, in particular a symptomless myocardial dysfunction, may also develop into heart failure. A myocardial dysfunction may also be a severe chronic heart failure. In general, a myocardial dysfunction is an impaired systolic and/or diastolic function of the heart, and a myocardial dysfunction may occur with or without heart failure. Any heart failure mentioned beforehand may be symptomless.

The term “heart failure” as used herein relates to an impaired systolic and/or diastolic function of the heart. in some embodiments, heart failure referred to herein is also chronic heart failure. Heart failure can be classified into a functional classification system according to the New York Heart Association (NYHA). Patients of NYHA Class I have no obvious symptoms of cardiovascular disease but already have objective evidence of functional impairment. Physical activity is not limited, and ordinary physical activity does not cause undue fatigue, palpitation, or dyspnea (shortness of breath). Patients of NYHA class II have slight limitation of physical activity. They are comfortable at rest, but ordinary physical activity results in fatigue, palpitation, or dyspnea. Patients of NYHA class III show a marked limitation of physical activity. They are comfortable at rest, but less than ordinary activity causes fatigue, palpitation, or dyspnea. Patients of NYHA class IV are unable to carry out any physical activity without discomfort. They show symptoms of cardiac insufficiency at rest. Heart failure, i.e., an impaired systolic and/or diastolic function of the heart, can be determined also by, for example, echocardiography, angiography, szintigraphy, or magnetic resonance imaging. This functional impairment can be accompanied by symptoms of heart failure as outlined above (NYHA class II-IV), although some patients may present without significant symptoms (NYHA I). Moreover, heart failure is also apparent by a reduced left ventricular ejection fraction (LVEF). In some embodiments, heart failure as used herein is accompanied by a left ventricular ejection fraction (LVEF) of less than 60%, of 40 to 60% or of less than 40%.

Also, in accordance with the present disclosure, and with respect to the reference values cited beforehand, an increased amount of GDF-15 is indicative for inflammatory processes occurring in the body of the patient, such as in the myocard, whereas with respect to the reference values a decreased amount of GDF-15 is indicative for the absence of inflammatory processes. Thus, in one embodiment of the method of the present disclosure, an increased amount of GDF-15 is indicative for inflammatory processes, whereas a decreased amount of GDF-15 is indicative for the absence of inflammatory processes.

Moreover, it has been found that each of said biomarkers is statistically independent from each other.

The present disclosure, in some embodiments, also relates to a method of deciding on the treatment of a subject as referred to above based on the aforementioned steps. Therefore, the method of the present disclosure allows to decide which pharmaceutical or pharmaceuticals should be taken by said subject or which other therapy the subject should undergo, e.g. to focus more on the treatment of pathological left ventricular hypertrophy (caused by one or more of arterial hypertension, aortic stenosis or hypertrophic cardiomyopathy), or to focus more on preventing further deterioration of the pathological left ventricular hypertrophy.

The present disclosure therefore also relates to a method of deciding on the therapy for treating pathological left ventricular hypertrophy in an individual suffering from the said disease, comprising the steps of:
a) determining the amounts of at least one marker selected from necrosis markers, at least one marker selected from cardiac function markers and at least one marker selected from inflammatory markers, in at least one sample of said subject,
b) comparing the thus determined amounts of the said markers as determined in step a) to suitable reference amounts, and
c) deciding on the therapy, based on the comparison carried out in step b).

The method of deciding on the therapy for treating pathological left ventricular hypertrophy in an individual suffering from the said disease, may also comprise the steps of:
a) determining the amounts of at least one marker selected from necrosis markers, at least one marker selected from cardiac function markers and at least one marker selected from inflammatory markers, in at least one sample of said subject,
b) deciding on the therapy by comparing the thus determined amounts of the said markers as determined in step a) to suitable reference amounts.

The present disclosure, thus, relates to a method of deciding on the therapy for treating pathological left ventricular hypertrophy in an individual suffering from the said disease based on the determination of the amounts of at least one marker selected from necrosis markers, at least one marker selected from cardiac function markers and at least one marker selected from inflammatory markers, in at least one sample of said subject and the comparison of the determined amounts of the said markers to suitable reference amounts.

The disclosure also encompasses the use of at least one marker selected from necrosis markers, at least one marker selected from cardiac function markers and at least one marker selected from inflammatory markers for the preparation of a diagnostic for deciding on the therapy for treating pathological left ventricular hypertrophy in an individual suffering from the said disease.

In one embodiment, the cardiac function marker is a natriuretic peptide, such as BNP or NT-proBNP, suitably NT-proBNP; preferably, the inflammatory marker is GDF-15; suitably, the necrosis marker is selected from troponin T and troponin I, suitably the necrosis marker is troponin T. In some embodiments, the following markers are determined in combination: NT-proBNP, GDF-15 and troponin T, and optionally also PIG F.

In one embodiment of this aspect of the present disclosure, the angiogenesis marker PIGF is measured in addition to the at least three markers specified beforehand. By this, additional information on the appropriate therapy may be available.

In accordance with the present disclosure, and with respect to the above-cited reference values, a decreased amount of PIGF is indicative for an anti-angiogenic status, whereas with respect to the reference values, an increased amount of PIGF is indicative for a pro-angiogenic status. An angiogenic (“pro-angiogenic”) status is indicative for the occurrence of ischemic states or processes, whereas an anti-angiogenic status is indicative for the non-occurrence of ischemic states or processes.

In a further embodiment of the present disclosure, the supplementary/complementary methods as laid out beforehand can be used for the methods of deciding on the treatment of a subject as referred to above, based on the aforementioned steps.

The term “therapy” as used in the context of the present disclosure encompasses interventions on the body as well as administration of appropriate drugs for the treatment of left ventricular hypertrophy, in particular left ventricular hypertrophy caused by one or more of arterial hypertension, aortic stenosis or hypertrophic cardiomyopathy. Pharmaceuticals suitable for the treatment of left ventricular hypertrophy are well known in the art, see e.g. Heart Disease, 2005, 7^{th} Edition, Eds. Braunwald, Elsevier Sounders, see tables 23-1, 23-6, 23-7, 23-8, 23-9, 23-10, which are incorporated herein by reference and which are a part of the present disclosure. in some embodiments, the administration of such pharmaceuticals aims to treat the symptoms and signs of left ventricular hypertrophy caused by one or more of arterial hypertension, aortic stenosis or hypertrophic cardiomyopathy and which aim to prevent a further progression of left ventricular hypertrophy. Accordingly, also contemplated are pharmaceuticals that aim to treat left ventricular dysfunction and/or heart failure, anti-inflammatory drugs.

The therapy may also include interventions. One exemplary intervention in the context of the present disclosure is controlled destruction of areas of the heart muscle by alcohol (ablation), in particular TASH (transcoronary ablation of septum hypertrophy) or PTSMA (percutaneous transluminal septal myocardial ablation), in case of an obstructive hypertrophic cardiomyopathy.

Another exemplary intervention is aortic valve replacement (AVR) in case of an aortic stenosis.

The present disclosure, therefore, also includes a method of deciding on the treatment of a patient suffering from hypertrophic cardiomyopathy. The term “deciding” as used herein means assessing as to whether a certain medication or treatment should be administered to a subject having undergone the test according to the present disclosure. The treatment is selected from the following:

Treatment A):

a) change in life style, in particular low sodium intake

b) administration of an agent or agents effecting cardiac function, for example: beta blockers like proprenolol, metoprolol, bisoprolol, carvedilol, bucindolol, nebivolol; nitrates; adrenergic agonists, like dobutamine, dopamine, epinephrine, isoprotenerol, norepinephrine, phenylephrine; positive inotropic agents, like digoxin, digitoxin; diuretics, in particular loop diuretics, thiazide and thiazide-like diuretics, K-sparing diuretics, type I mineralocorticoid receptor antagonists, carbonic anhydrase inhibitors, vasopressure antagonists.

The information whether these agents should be administered is provided if an elevated level of the cardiac function marker, for example a natriuretic peptide is measured. Suitable natriuretic peptides are BNP, NT-proBNP, ANP, NT-proANP; suitably BNP or NT-proBNP, suitably NT-proBNP.

When a level of natriuretic peptide of, in the case of NT-proBNP, ≧ about 300 pg/ml, suitably ≧ about 500 pg/ml, suitably ≧ about 800 pg/ml, suitably ≧ about 2000 pg/ml is reached, one or more of the above-cited drugs may be administered. Also in some embodiments, the reference amount is the amount of the natriuretic peptide corresponding to the 50^{th} or 75^{th} percentile determined in a collective of patients suffering from hypertrophic cardiomyopathy.

The levels of natriuretic peptides, in particular NT-proBNP cited beforehand (≧ about 300 pg/ml, suitably ≧ about 500 pg/ml, suitably ≧ about 800 pg/ml, suitably ≧ about 2000 pg/ml) may also indicate that, in case of an obstructive hypertrophic cardiomyopathy, an ablation, such as TASH, may be carried out. The diagnosis of obstructive hypertrophic cardiomyopathy as such has to be established by methods known to the person skilled in the art, like heart sounds, echocardiography, electrocardiography (ECG), chest x-ray and/or cardiac catheterization; or by methods disclosed in the present application, like forming the ratio between a cardiac function marker (NT-proBNP) and an inflammatory marker (GDF-15).

Treatment B):

Administration of one or more anti-inflammatory drugs, such as: ACE inhibitors, in particular Enalapril, Captopril, Ramipril, Trandolapril; angiotensin receptor antagonists and aldosterone antagonists, in particular Losartan, Valsartan, Irbesartan, Candesartan, Telmisartan, Eprosartan, Spironolactone; statines, in particular Atorvastatin, Fluvastatin, Lovastatin, Pravastatin, Rosuvastatin, Simvastatin;

The information whether these agents may be administered is provided if an elevated level of an inflammatory maker, suitably GDF-15 which is indicative for inflammatory processes is measured.

When a level of GDF-15 of ≧ about 800 pg/ml, suitably ≧ about 1200 pg/ml, suitably ≧ about 1500 pg/ml, suitably ≧ about 2000 pg/ml is reached, one or more of the above-cited drugs may be administered. Also in some embodiments, the reference amount is the amount of GDF-15 corresponding to the 50^{th} or 75^{th} percentile determined in a collective of patients suffering from hypertrophic cardiomyopathy.

Treatment C):

Treatment of percutane coronary intervention: In general, the level of a necrosis marker, suitably Troponin I and/or T, suitably Troponin T, is indicative of an existing myocardial necrosis and the extent of the necrosis; in case no drop in the level of Troponin T or Troponin I is observed, then this peptide indicates heart failure and/or vascular stenosis; vascular stenosis can be treated by percutane coronary intervention.

The information whether these agents may beneficially be administered if an elevated level of Troponin I and/or Troponin T, suitably Troponin T of ≧ about 3 pg/ml, suitably ≧ about 4 pg/ml, suitably ≧ about 5 pg/ml which is indicative for heart failure or vascular stenosis is measured. Also in some embodiments, the reference amount is the amount of Troponin I or Troponin T corresponding to the 50^{th} or 75^{th} percentile determined in a collective of patients suffering from hypertrophic cardiomyopathy.

Treatment D):

Administration of at Least One Medicament for a Pro-Angiogenic Therapy

The term “pro-angiogenic therapy” as recited above relates to a therapy which induces or enhances the process of angiogenesis systemically or topically in a subject and includes the treatment of micro- and macroangiopathy. In some embodiments, said pro-angiogenic therapy comprises administration of a pro-angiogenic drug, in some embodiments, selected from the group consisting of: VEGF, PIGF, Endoglin, anti-Flt-1 antibodies and ALK5 modifiers. These drugs can be used for the treatment of both micro- and macroangiopathy.

The term “susceptible” as used herein means that a statistically significant portion of subjects identified by the method as being susceptible respond to the envisaged therapy by showing angiogenesis in the affected areas of the heart.

The information whether these agents should be administered is provided if an elevated (lowered) level of PIGF which is indicative for anti-angiogenic processes is measured.

In one embodiment of the aforementioned method, an increased amount of PLGF identifies a subject as being susceptible to a pro-angiogenic therapy.

When a level of PIGF of ≧ about 8 pg/ml, suitably ≧ about 10 pg/ml, suitably ≧ about 12 pg/ml, suitably ≧ about 15 pg/ml is reached, one or more of the above-cited drugs may be administered. Also in some embodiments, the reference amount is the amount of PIGF corresponding to the 50^{th} or 75th percentile determined in a collective of patients suffering from hypertrophic cardiomyopathy.

The present disclosure furthermore relates to a method of monitoring the therapy of treating pathological left ventricular hypertrophy in an individual suffering from the said disease, comprising the steps of:
a) determining the amounts of at least one marker selected from necrosis markers, at least one marker selected from cardiac function markers and at least one marker selected from inflammatory markers, in at least one sample of said subject,
b) comparing the thus determined amounts of the said markers as determined in step a) to suitable reference amounts, and
c) as the case may be, adapting or discontinuing the therapy, based on the comparison carried out in step b).

The present disclosure also covers using at least one marker selected from necrosis markers, at least one marker selected from cardiac function markers and at least one marker selected from inflammatory markers, as defined above, for monitoring the therapy of treating pathological left ventricular hypertrophy in an individual suffering from the said disease.

The reference amounts cited in step b) may be the reference amounts cited in the present application in respect to the therapy decision beforehand under A), B), C) and D), or may be amounts determined before the therapy was initiated, or both.

In respect to the necrosis marker, suitably Troponin I or Troponin T, suitably Troponin T, a deviation of about 10%, about 20%, about 30%, about 40% or about 50%, e.g., about 20%, from the corresponding reference amount is indicative for an amelioration (in case of a decrease of the marker amounts) or a deterioration (in case of an increase of the marker amounts) of the pathological state of the individual.

In respect to the cardiac function marker, such as a natriuretic peptide, e.g., BNP or NT-proBNP, suitably NT-proBNP, a deviation of about 10%, about 20%, about 30%, about 40% or about 50%, e.g., about 20%, from the corresponding reference amount is indicative for an amelioration (in case of a decrease of the marker amounts) or a deterioration (in case of an increase of the marker amounts) of the pathological state of the individual.

In one embodiment of the present application, a natriuretic peptide, suitably BNP or NT-proBNP, suitably NT-proBNP, serves as a marker to monitor TASH therapy in an individual. It could be established, by the inventors of the present application that the level of a natriuretic peptide, suitably BNP or NT-proBNP, suitably NT-proBNP, diminishes after successful TASH intervention. A deviation of about 10%, about 20%, about 30%, about 40% or about 50%, e.g., about 20%, from the corresponding reference amount is indicative of a successful TASH intervention.

In respect to the inflammatory marker, in particular GDF-15, a deviation of about 10%, about 20%, about 30%, about 40% or about 50%, e.g., about 20%, from the corresponding reference amount is indicative for an amelioration (in case of a decrease of the marker amounts) or a deterioration (in case of an increase of the marker amounts) of the pathological state of the individual.

The present inventors found that based on the measurement of the amount of the at least one marker in the sample from a subject it was possible to decide on the treatment of the various forms of pathological left ventricular hypertrophy, (i.e. hypertrophic non-obstructive cardiomyopathy, hypertrophic obstructive cardiomyopathy or pressure overload hypertrophy), and to monitor the treament, without having to refer to costly and time-consuming diagnostic methods known to the person skilled in the art and laid out elsewhere in the specification.

In one embodiment of the present disclosure, the angiogenesis marker PIGF is measured in addition to the at least three markers specified beforehand. By this, additional on the pathological state of the individual and the therapy success may be available.

In respect to PIGF, a deviation of about 10%, about 20%, about 30%, about 40% or about 50%, in particular about 20%, from the corresponding reference amount is indicative for an amelioration (in case of a decrease of the marker amounts) or a deterioration (in case of an increase of the marker amounts) of the pathological state of the individual.

In general, prior to carrying out the monitoring method of the present disclosure, the method of deciding on the therapy of treating left ventricular hypertrophy is carried out, in one embodiment of the present disclosure.

Determining the amount of a cardiac function marker, suitably a natriuretic peptide, a necrosis marker, suitably a cardiac troponin, an inflammatory marker, suitably GDF-15, or an angionesis marker, suitably PIGF, or any other peptide or polypeptide referred to in this specification relates to measuring the amount or concentration, semi-quantitatively or quantitatively. Measuring can be done directly or indirectly. Direct measuring relates to measuring the amount or concentration of the peptide or polypeptide based on a signal which is obtained from the peptide or polypeptide itself and the intensity of which directly correlates with the number of molecules of the peptide present in the sample. Such a signal—sometimes referred to herein as intensity signal—may be obtained, e.g., by measuring an intensity value of a specific physical or chemical property of the peptide or polypeptide. Indirect measuring includes measuring of a signal obtained from a secondary component (i.e. a component not being the peptide or polypeptide itself) or a biological read out system, e.g., measurable cellular responses, ligands, labels, or enzymatic reaction products.

The term “sample” refers to a sample of a body fluid, to a sample of separated cells or to a sample from a tissue or an organ. Samples of body fluids can be obtained by well-known techniques and include without limitation, samples of blood, plasma, serum, urine, samples of blood, plasma or serum. It is to be understood that the sample depends on the marker to be determined. Therefore, it is encompassed that the polypeptides as referred to herein are determined in different samples. Cardiac troponins and natriuretic peptides are, in some embodiments, determined in a blood serum or blood plasma sample.

In accordance with the present disclosure, determining the amount of a peptide or polypeptide can be achieved by all known means for determining the amount of a peptide in a sample. Said means comprise immunoassay devices and methods which may utilize labeled molecules in various sandwich, competition, or other assay formats. Said assays will develop a signal which is indicative for the presence or absence of the peptide or polypeptide. Moreover, the signal strength can, in some embodiments, can be correlated directly or indirectly (e.g. reverse-proportional) to the amount of polypeptide present in a sample. Further suitable methods comprise measuring a physical or chemical property specific for the peptide or polypeptide such as its precise molecular mass or NMR spectrum. Said methods comprise, in some embodiments, biosensors, optical devices coupled to immunoassays, biochips, analytical devices such as mass-spectrometers, NMR-analyzers, or chromatography devices. Further, methods include micro-plate ELISA-based methods, fully-automated or robotic immunoassays (available for example on Elecsys™ analyzers), CBA (an enzymatic Cobalt Binding Assay, available for example on Roche-Hitachi™ analyzers), and latex agglutination assays (available for example on Roche-Hitachi™ analyzers).

In some embodiments, determining the amount of a peptide or polypeptide comprises the steps of (a) contacting a cell capable of eliciting a cellular response the intensity of which is indicative of the amount of the peptide or polypeptide with the said peptide or polypeptide for an adequate period of time, (b) measuring the cellular response. For measuring cellular responses, the sample or processed sample is, in some embodiments, added to a cell culture and an internal or external cellular response is measured. The cellular response may include the measurable expression of a reporter gene or the secretion of a substance, e.g. a peptide, polypeptide, or a small molecule. The expression or substance shall generate an intensity signal which correlates to the amount of the peptide or polypeptide.

Also in some embodiments, determining the amount of a peptide or polypeptide comprises the step of measuring a specific intensity signal obtainable from the peptide or polypeptide in the sample. As described above, such a signal may be the signal intensity observed at an m/z variable specific for the peptide or polypeptide observed in mass spectra or a NMR spectrum specific for the peptide or polypeptide.

Determining the amount of a peptide or polypeptide may, in some embodiments, comprise the steps of (a) contacting the peptide with a specific ligand, (b) (optionally) removing non-bound ligand, (c) measuring the amount of bound ligand. The bound ligand will generate an intensity signal. Binding according to the present disclosure includes both covalent and non-covalent binding. A ligand according to the present disclosure can be any compound, e.g., a peptide, polypeptide, nucleic acid, or small molecule, binding to the peptide or polypeptide described herein. Suitable ligands include antibodies, nucleic acids, peptides or polypeptides such as receptors or binding partners for the peptide or polypeptide and fragments thereof comprising the binding domains for the peptides, and aptamers, e.g. nucleic acid or peptide aptamers. Methods to prepare such ligands are well-known in the art. For example, identification and production of suitable antibodies or aptamers is also offered by commercial suppliers. The person skilled in the art is familiar with methods to develop derivatives of such ligands with higher affinity or specificity. For example, random mutations can be introduced into the nucleic acids, peptides or polypeptides. These derivatives can then be tested for binding according to screening procedures known in the art, e.g. phage display. Antibodies as referred to herein include both polyclonal and monoclonal antibodies, as well as fragments thereof, such as Fv, Fab and F(ab)₂ fragments that are capable of binding antigen or hapten. The present disclosure also includes single chain antibodies and humanized hybrid antibodies wherein amino acid sequences of a non-human donor antibody exhibiting a desired antigen-specificity are combined with sequences of a human acceptor antibody. The donor sequences will usually include at least the antigen-binding amino acid residues of the donor but may comprise other structurally and/or functionally relevant amino acid residues of the donor antibody as well. Such hybrids can be prepared by several methods well known in the art. Suitably, the ligand or agent binds specifically to the peptide or polypeptide. Specific binding according to the present disclosure means that the ligand or agent should not bind substantially to (“cross-react” with) another peptide, polypeptide or substance present in the sample to be analyzed. Suitably, the specifically bound peptide or polypeptide should be bound with at least 3 times higher, in some embodiments, at least 10 times higher and even in some embodiments at least 50 times higher affinity than any other relevant peptide or polypeptide. Non-specific binding may be tolerable, if it can still be distinguished and measured unequivocally, e.g. according to its size on a Western Blot, or by its relatively higher abundance in the sample. Binding of the ligand can be measured by any method known in the art. In some embodiments, said method is semi-quantitative or quantitative. Suitable methods are described in the following.

First, binding of a ligand may be measured directly, e.g. by NMR or surface plasmon resonance.

Second, if the ligand also serves as a substrate of an enzymatic activity of the peptide or polypeptide of interest, an enzymatic reaction product may be measured (e.g. the amount of a protease can be measured by measuring the amount of cleaved substrate, e.g. on a Western Blot). Alternatively, the ligand may exhibit enzymatic properties itself and the “ligand/peptide or polypeptide” complex or the ligand which was bound by the peptide or polypeptide, respectively, may be contacted with a suitable substrate allowing detection by the generation of an intensity signal. For measurement of enzymatic reaction products, in some embodiments, the amount of substrate is saturating. The substrate may also be labeled with a detectable label prior to the reaction. In some embodiments, the sample is contacted with the substrate for an adequate period of time. An adequate period of time refers to the time necessary for a detectable, suitably measurable, amount of product to be produced. Instead of measuring the amount of product, the time necessary for appearance of a given (e.g. detectable) amount of product can be measured.

Third, the ligand may be coupled covalently or non-covalently to a label allowing detection and measurement of the ligand. Labelling may be done by direct or indirect methods. Direct labelling involves coupling of the label directly (covalently or non-covalently) to the ligand. Indirect labelling involves binding (covalently or non-covalently) of a secondary ligand to the first ligand. The secondary ligand should specifically bind to the first ligand. Said secondary ligand may be coupled with a suitable label and/or be the target (receptor) of tertiary ligand binding to the secondary ligand. The use of secondary, tertiary or even higher order ligands is often used to increase the signal. Suitable secondary and higher order ligands may include antibodies, secondary antibodies, and the well-known streptavidin-biotin system (Vector Laboratories, Inc.). The ligand or substrate may also be “tagged” with one or more tags as known in the art. Such tags may then be targets for higher order ligands. Suitable tags include biotin, digoxygenin, His-Tag, Glutathion-S-Transferase, FLAG, GFP, myc-tag, influenza A virus haemagglutinin (HA), maltose binding protein, and the like. In the case of a peptide or polypeptide, the tag is in some embodiments, at the N-terminus and/or C-terminus. Suitable labels are any labels detectable by an appropriate detection method. Typical labels include gold particles, latex beads, acridan ester, luminol, ruthenium, enzymatically active labels, radioactive labels, magnetic labels (“e.g. magnetic beads”, including paramagnetic and superparamagnetic labels), and fluorescent labels. Enzymatically active labels include e.g. horseradish peroxidase, alkaline phosphatase, beta-Galactosidase, Luciferase, and derivatives thereof. Suitable substrates for detection include di-amino-benzidine (DAB), 3,3′-5,5′-tetramethylbenzidine, NBT-BCIP (4-nitro blue tetrazolium chloride and 5-bromo-4-chloro-3-indolyl-phosphate, available as ready-made stock solution from Roche Diagnostics), CDP-Star™ (Amersham Biosciences), ECF™ (Amersham Biosciences). A suitable enzyme-substrate combination may result in a colored reaction product, fluorescence or chemoluminescence, which can be measured according to methods known in the art (e.g. using a light-sensitive film or a suitable camera system). As for measuring the enzymatic reaction, the criteria given above apply analogously. Typical fluorescent labels include fluorescent proteins (such as GFP and its derivatives), Cy3, Cy5, Texas Red, Fluorescein, and the Alexa dyes (e.g. Alexa 568). Further fluorescent labels are available e.g. from Molecular Probes (Oregon). Also the use of quantum dots as fluorescent labels is contemplated. Typical radioactive labels include ³⁵S, ¹²⁵I, ³²P, ³³P and the like. A radioactive label can be detected by any method known and appropriate, e.g. a light-sensitive film or a phosphor imager. Suitable measurement methods according the present disclosure also include precipitation (particularly immunoprecipitation), electrochemiluminescence (electro-generated chemiluminescence), RIA (radioimmunoassay), ELISA (enzyme-linked immunosorbent assay), sandwich enzyme immune tests, electrochemiluminescence sandwich immunoassays (ECLIA), dissociation-enhanced lanthanide fluoro immuno assay (DELFIA), scintillation proximity assay (SPA), turbidimetry, nephelometry, latex-enhanced turbidimetry or nephelometry, or solid phase immune tests. Further methods known in the art (such as gel electrophoresis, 2D gel electrophoresis, SDS polyacrylamid gel electrophoresis (SDS-PAGE), Western Blotting, and mass spectrometry), can be used alone or in combination with labelling or other detection methods as described above.

The amount of a peptide or polypeptide may be, also suitably, determined as follows: (a) contacting a solid support comprising a ligand for the peptide or polypeptide as specified above with a sample comprising the peptide or polypeptide and (b) measuring the amount peptide or polypeptide which is bound to the support. The ligand, suitably chosen from the group consisting of nucleic acids, peptides, polypeptides, antibodies and aptamers, is suitably present on a solid support in immobilized form. Materials for manufacturing solid supports are well known in the art and include, inter alia, commercially available column materials, polystyrene beads, latex beads, magnetic beads, colloid metal particles, glass and/or silicon chips and surfaces, nitrocellulose strips, membranes, sheets, duracytes, wells and walls of reaction trays, plastic tubes etc. The ligand or agent may be bound to many different carriers. Examples of well-known carriers include glass, polystyrene, polyvinyl chloride, polypropylene, polyethylene, polycarbonate, dextran, nylon, amyloses, natural and modified celluloses, polyacrylamides, agaroses, and magnetite. The nature of the carrier can be either soluble or insoluble for the purposes of the disclosure. Suitable methods for fixing/immobilizing said ligand are well known and include, but are not limited to ionic, hydrophobic, covalent interactions and the like. It is also contemplated to use “suspension arrays” as arrays according to the present disclosure (Nolan 2002, Trends Biotechnol. 20(1):9-12). In such suspension arrays, the carrier, e.g. a microbead or microsphere, is present in suspension. The array consists of different microbeads or microspheres, possibly labeled, carrying different ligands. Methods of producing such arrays, for example based on solid-phase chemistry and photo-labile protective groups, are generally known (U.S. Pat. No. 5,744,305).

The term “amount” as used herein encompasses the absolute amount of a polypeptide or peptide, the relative amount or concentration of the said polypeptide or peptide as well as any value or parameter which correlates thereto or can be derived therefrom. Such values or parameters comprise intensity signal values from all specific physical or chemical properties obtained from the said peptides by direct measurements, e.g., intensity values in mass spectra or NMR spectra. Moreover, encompassed are all values or parameters which are obtained by indirect measurements specified elsewhere in this description, e.g., response levels determined from biological read out systems in response to the peptides or intensity signals obtained from specifically bound ligands. It is to be understood that values correlating to the aforementioned amounts or parameters can also be obtained by all standard mathematical operations.

The term “comparing” as used herein encompasses comparing the amount of the peptide or polypeptide comprised by the sample to be analyzed with an amount of a suitable reference source specified elsewhere in this description. It is to be understood that comparing as used herein refers to a comparison of corresponding parameters or values, e.g., an absolute amount is compared to an absolute reference amount while a concentration is compared to a reference concentration or an intensity signal obtained from a test sample is compared to the same type of intensity signal of a reference sample. The comparison referred to in step (b) of the method of the present disclosure may be carried out manually or computer assisted. For a computer assisted comparison, the value of the determined amount may be compared to values corresponding to suitable references which are stored in a database by a computer program. The computer program may further evaluate the result of the comparison, i.e. automatically provide the desired assessment in a suitable output format. Based on the comparison of the amount determined in step a) and the reference amount, it is possible to assess whether a subject is susceptible for a cardiac therapy and, thus, belongs to the group of subjects which can be successfully treated by the cardiac therapy. Therefore, the reference amount is to be chosen so that either a difference or a similarity in the compared amounts allows identifying those the test subject which belong into the group of subjects susceptible for cardiac therapy or identifying those test subjects which are not susceptible for a cardiac therapy.

The present disclosure further encompasses a device for diagnosing or distinguishing, in a subject having left ventricular hypertrophy, if the subject has physiological left ventricular hypertrophy or suffers from pathological left ventricular hypertrophy; or for distinguishing, in a subject suffering from pathological left ventricular hypertrophy, if the subject suffers from hypertrophic non-obstructive cardiomyopathy, hypertrophic obstructive cardiomyopathy or pressure overload hypertrophy, comprising:
a) means for determining the amounts of the following peptides:

a necrosis marker, such as troponin or a variant thereof;

a cardiac function marker, such as a natriuretic peptide or a variant thereof;

an inflammatory marker, such as GDF-15 or a variant thereof; and optionally means for determining the amount of PIGF or a variant thereof;
b) means for comparing the amounts determined in step a) with reference amounts, whereby the pathomechanism(s) of the left ventricular hypertrophy is to be diagnosed.

Depending on the results obtainable by the device according to the disclosure, a decision on the adaptation of the therapy may be taken. The therapy may be adapted by e.g. augmenting or diminishing the amounts of the medicaments which are administrated.

The present disclosure further encompasses a device for deciding on the therapy in a subject suffering from pathological left ventricular hypertrophy comprising:
a) means for determining the amounts of the following peptides:

a necrosis marker, suitably troponin or a variant thereof;

a cardiac function marker, suitably a natriuretic peptide or a variant thereof;

an inflammatory marker, suitably GDF-15 or a variant thereof; and optionally means for determining the amount of PIGF or a variant thereof; and
b) means for comparing the amounts determined in step a) with reference amounts, whereby the pathomechanism(s) of the left ventricular hypertrophy is to be diagnosed,
whereby the device is adapted for carrying out the method of the present disclosure referred to above.

The term “device” as used herein relates to a system of means comprising at least the aforementioned means operatively linked to each other as to allow the prediction. Suitable means for determining the amount of a one of the aforementioned polypeptides as well as means for carrying out the comparison are disclosed above in connection with the method of the disclosure. How to link the means in an operating manner will depend on the type of means included into the device. For example, where means for automatically determining the amount of the peptides are applied, the data obtained by said automatically operating means can be processed by, e.g., a computer program in order to obtain the desired results. In some embodiments, the means are comprised by a single device in such a case. Said device may accordingly include an analyzing unit for the measurement of the amount of the peptides or polypeptides in an applied sample and a computer unit for processing the resulting data for the evaluation. The computer unit, in some embodiments, comprises a database including the stored reference amounts or values thereof recited elsewhere in this specification as well as a computer-implemented algorithm for carrying out a comparison of the determined amounts for the polypeptides with the stored reference amounts of the database. Computer-implemented as used herein refers to a computer-readable program code tangibly included into the computer unit. Alternatively, where means such as test stripes are used for determining the amount of the peptides or polypeptides, the means for comparison may comprise control stripes or tables allocating the determined amount to a reference amount. The test stripes are, in some embodiments, coupled to a ligand which specifically binds to the peptides or polypeptides referred to herein. The strip or device, in some embodiments, comprises means for detection of the binding of said peptides or polypeptides to the said ligand. Suitable means for detection are disclosed in connection with embodiments relating to the method of the disclosure above. In such a case, the means are operatively linked in that the user of the system brings together the result of the determination of the amount and the diagnostic or prognostic value thereof due to the instructions and interpretations given in a manual. The means may appear as separate devices in such an embodiment and are, suitably, packaged together as a kit. The person skilled in the art will realize how to link the means without further ado. Suitable devices are those which can be applied without the particular knowledge of a specialized clinician, e.g., test stripes or electronic devices which merely require loading with a sample. The results may be given as output of raw data which need interpretation by the clinician. Suitably, the output of the device is, however, processed, i.e. evaluated, raw data the interpretation of which does not require a clinician. Further embodiments of devices comprise the analyzing units/devices (e.g., biosensors, arrays, solid supports coupled to ligands specifically recognizing the natriuretic peptide, Plasmon surface resonance devices, NMR spectrometers, mass-spectrometers etc.) and/or evaluation units/devices referred to above in accordance with the method of the disclosure.

Also, the present disclosure relates to a device for monitoring the therapy in a subject suffering from pathological left ventricular hypertrophy cardiomyopathy comprising:
a) means for determining the amounts of the following peptides:

a necrosis marker, suitably troponin or a variant thereof;

a cardiac function marker, suitably a natriuretic peptide or a variant thereof;

an inflammatory marker, suitably GDF-15 or a variant thereof; and optionally means for determining the amount of PIGF or a variant thereof; and
b) means for comparing the amounts determined in step a) with reference amounts, whereby the pathomechanism(s) of the left ventricular hypertrophy is to be diagnosed,
whereby the device is adapted for carrying out the method of the present disclosure referred to above.

The present disclosure also relates to the use of a device or devices as cited beforehand, for:
diagnosing or distinguishing, in a subject having left ventricular hypertrophy, if the subject has physiological left ventricular hypertrophy or suffers from pathological left ventricular hypertrophy; or for
distinguishing, in a subject suffering from pathological left ventricular hypertrophy, if the subject suffers from hypertrophic non-obstructive cardiomyopathy, hypertrophic obstructive cardiomyopathy or pressure overload hypertrophy; or for
deciding on and/or monitoring the therapy in a subject suffering from pathological left ventricular hypertrophy.

Moreover, the present disclosure relates to a kit adapted for carrying out the method of the present disclosure referred to above comprising:
a) means for determining the amounts of the following peptides:

a necrosis marker, suitably troponin or a variant thereof;

a cardiac function marker, suitably a natriuretic peptide or a variant thereof;

an inflammatory marker, suitably GDF-15 or a variant thereof; and optionally means for determining the amount of PIGF or a variant thereof; and
b) means for comparing the amounts determined in step a) with reference amounts, whereby the pathomechanism(s) of the left ventricular hypertrophy is to be diagnosed,
whereby the kit is adapted for carrying out the method of the present disclosure referred to above. In some embodiments, the kit comprises instructions for carrying out the said method of the present disclosure.

The term “kit” as used herein refers to a collection of the aforementioned means, suitably, provided in separately or within a single container. The container, also suitably, comprises instructions for carrying out the method of the present disclosure.

The present disclosure also relates to the use of a kit or kits as cited beforehand, for: diagnosing or distinguishing, in a subject having left ventricular hypertrophy, if the subject has physiological left ventricular hypertrophy or suffers from pathological left ventricular hypertrophy; or for distinguishing, in a subject suffering from pathological left ventricular hypertrophy, if the subject suffers from hypertrophic non-obstructive cardiomyopathy, hypertrophic obstructive cardiomyopathy or pressure overload hypertrophy; or for deciding on and/or monitoring the therapy in a subject suffering from pathological left ventricular hypertrophy.

The present disclosure also relates to the use of: an antibody against at least one marker selected from necrosis markers, at least one marker selected from cardiac function markers and at least one marker selected from inflammatory markers and/or of means for determining the amount of at least one marker selected from necrosis markers, at least one marker selected from cardiac function markers and at least one marker selected from inflammatory markers and/or of means for comparing the amount of at least one marker selected from necrosis markers, at least one marker selected from cardiac function markers and at least one marker selected from inflammatory markers to at least one reference amount, for the manufacture of a diagnostic composition for: diagnosing if the subject has physiological left ventricular hypertrophy or is suffering from pathological left ventricular hypertrophy; distinguishing, in a subject suffering from pathological left ventricular hypertrophy, if the subject suffers from hypertrophic non-obstructive cardiomyopathy, hypertrophic obstructive cardiomyopathy or pressure overload hypertrophy; distinguishing, in a subject suffering from pathological left ventricular hypertrophy, if the subject suffers from hypertrophic non-obstructive cardiomyopathy, on the one hand, or from a cardiomyopathy selected from hypertrophic obstructive cardiomyopathy and pressure overload hypertrophy, on the other hand; deciding on the therapy for treating pathological left ventricular hypertrophy in a subject suffering from the said disease, and/or monitoring a therapy of treating pathological left ventricular hypertrophy in a subject suffering from the said disease.

The present disclosure also relates to the use of: at least one marker selected from necrosis markers, at least one marker selected from cardiac function markers and at least one marker selected from inflammatory markers and/or of means for determining the amount of at least one marker selected from necrosis markers, at least one marker selected from cardiac function markers and at least one marker selected from inflammatory markers and/or of means for comparing the amount of at least one marker selected from necrosis markers, at least one marker selected from cardiac function markers and at least one marker selected from inflammatory markers to at least one reference amount for: diagnosing if the subject has physiological left ventricular hypertrophy or is suffering from pathological left ventricular hypertrophy; distinguishing, in a subject suffering from pathological left ventricular hypertrophy, if the subject suffers from hypertrophic non-obstructive cardiomyopathy, hypertrophic obstructive cardiomyopathy or pressure overload hypertrophy; distinguishing, in a subject suffering from pathological left ventricular hypertrophy, if the subject suffers from hypertrophic non-obstructive cardiomyopathy, on the one hand, or from a cardiomyopathy selected from hypertrophic obstructive cardiomyopathy and pressure overload hypertrophy, on the other hand; deciding on the therapy for treating pathological left ventricular hypertrophy in a subject suffering from the said disease, and/or monitoring a therapy of treating pathological left ventricular hypertrophy in a subject suffering from the said disease.

It is also provided for a method for diagnosing a myocardial infarction in a patient comprising the steps of:
a) determining the amount of a cardiac troponin or a variant thereof in a sample of the patient;
b) comparing the measured amount of the cardiac troponin or the variant thereof to a reference amount;

whereby the results obtained in step b) indicate whether the patient suffers from a myocardial infarction.

In some embodiments, the method of the present disclosure comprises the steps of a) determining the amount of a cardiac troponin or a variant thereof in a sample of the patient; b) comparing the measured amount of the cardiac troponin or the variant thereof to a reference amount; and c) diagnosing whether the patient suffers from a myocardial infarction.

A further embodiment of the present disclosure relates to a method for diagnosing heart failure in a patient comprising the steps of:
a) determining the amount of a natriuretic peptide or a variant thereof in a sample of the patient;
b) comparing the measured amount of the natriuretic peptide or the variant thereof to a reference amount;

whereby the results obtained in step b) indicate whether the patient suffers from heart failure.

In some embodiments, the method of the present disclosure comprises the steps of a) determining the amount of a natriuretic peptide or a variant thereof in a sample of the patient; b) comparing the measured amount of the natriuretic peptide or the variant thereof to a reference amount; and c) diagnosing whether the patient suffers from a heart failure.

The following examples, sequence listing, and figures are provided for the purpose of demonstrating various embodiments of the instant disclosure and aiding in an understanding of the present disclosure, the true scope of which is set forth in the appended claims. These examples are not intended to, and should not be understood as, limiting the scope or spirit of the instant disclosure in any way. It should also be understood that modifications can be made in the procedures set forth without departing from the spirit of the disclosure.

Illustrative Embodiments

In one illustrative embodiment, a method for diagnosing or distinguishing, in a subject having left ventricular hypertrophy, if the subject has physiological left ventricular hypertrophy or suffers from pathological left ventricular hypertrophy is provided. In some embodiments, the method includes the steps of a) determining the amounts of at least one marker selected from necrosis markers, at least one marker selected from cardiac function markers and at least one marker selected from inflammatory markers, in at least one sample of said subject, b) comparing the amounts of the said markers as determined in step a) to suitable reference amounts, and c) diagnosing if the subject has physiological left ventricular hypertrophy or is suffering from pathological left ventricular hypertrophy.

In some embodiments, the necrosis marker is troponin I or T or a variant thereof. In some embodiments, the cardiac function marker is a BNP-type marker, suitably, BNP or NT-proBNP or a variant thereof. In some embodiments, the inflammatory marker is GDF-15 or a variant thereof.

In some embodiments, the following values are indicative for a subject having pathological left ventricular hypertrophy: cardiac troponin or a variant thereof, suitably troponin I or troponin T or a variant thereof, suitably troponin T or a variant thereof: > about 5 pg/ml; natriuretic peptide, suitably BNP or NT-proBNP or a variant thereof, suitably NT-proBNP or a variant thereof: > about 75 pg/ml; inflammatory marker, suitably GDF-15: > about 600 pg/ml.

In some embodiments, the cardiac troponin is troponin T or a variant thereof, the natriuretic peptide is NT-proBNP or a variant thereof and the inflammatory marker is GDF-15 or a variant thereof.

In yet another illustrative embodiment, a method for distinguishing, in a subject suffering from pathological left ventricular hypertrophy, if the subject suffers from hypertrophic non-obstructive cardiomyopathy, hypertrophic obstructive cardiomyopathy or pressure overload hypertrophy, is provided. In some embodiments, the method includes the steps of a) determining the amounts of at least one marker selected from cardiac function markers, at least one markers selected from necrosis markers, and at least one marker selected from inflammatory markers, in at least one sample of said subject, b) comparing the amounts as determined in step a) to reference amounts, and c) distinguishing between hypertrophic non-obstructive cardiomyopathy, hypertrophic obstructive cardiomyopathy and pressure overload hypertrophy, depending on the results of step b).

In yet another illustrative embodiment, a method for distinguishing, in a subject suffering from pathological left ventricular hypertrophy, if the subject suffers from hypertrophic non-obstructive cardiomyopathy, on the one hand, or from a cardiomyopathy selected from hypertrophic obstructive cardiomyopathy and pressure overload hypertrophy, on the other hand, is provided. In some embodiments, the method includes the steps of a) determining the amounts of at least one marker selected from cardiac function markers and at least one marker selected from inflammatory markers, in at least one sample of said subject, b) forming a ratio between a cardiac function marker and an inflammatory marker as determined in step a), c) comparing the ratio as determined in step b) to reference ratios, and d) distinguishing between hypertrophic non-obstructive cardiomyopathy, on the one hand, and a cardiomyopathy selected from hypertrophic obstructive cardiomyopathy and pressure overload hypertrophy, on the other hand, depending on the results of step c).

In some embodiments, the cardiac function marker is a natriuretic peptide, suitably BNP or NT-proBNP or a variant thereof, suitably NT-proBNP or a variant thereof, and the inflammatory marker is GDF-15 or a variant thereof. In some embodiments, NT-proBNP/GDF-15 ratio values indicative for the occurrence of hypertrophic non-obstructive cardiomyopathy are values > about 0.43, suitably >0.43. In some embodiments, the NT-proBNP/GDF-15 ratio values indicative for the occurrence of hypertrophic obstructive cardiomyopathy and pressure overload hypertrophy are values up to about 0.43, suitably <0.43.

In yet another illustrative embodiments, a method for distinguishing, in a subject suffering from pathological left ventricular hypertrophy, if the subject suffers from hypertrophic non-obstructive cardiomyopathy, hypertrophic obstructive cardiomyopathy or pressure overload hypertrophy, comprising the steps of a) determining the amounts of at least one marker selected from necrosis markers and at least one marker selected from inflammatory markers, in at least one sample of said subject, b) forming a ratio between the necrosis marker and an inflammatory marker as determined in step a), c) comparing the ratios amounts as determined in step c) to reference ratios, and d) distinguishing between hypertrophic non-obstructive cardiomyopathy, hypertrophic obstructive cardiomyopathy and pressure overload hypertrophy, depending on the results of step c).

In some embodiments, the necrosis marker is troponin T or troponin I or a variant thereof, suitably troponin T or a variant thereof, and the inflammatory marker is GDF-15 or a variant thereof. In some embodiments, troponin T/GDF-15 ratio values indicative for the occurrence of hypertrophic non-obstructive cardiomyopathy are values ≧ about 0.01, suitably values ≧0.01. In some embodiments, troponin T/GDF-15 ratio values indicative for the occurrence of hypertrophic obstructive cardiomyopathy and pressure overload hypertrophy are values ≦ about 0.004, suitably values ≦0.004. In some embodiments, troponin T/GDF-15 ratio values indicative for the occurrence of pressure overload hypertrophy are values ranging from > about 0.004 to < about 0.01. In some embodiments, the amount of PIGF or a variant thereof is determined.

In yet another illustrative embodiment, methods of diagnosing hypertrophic obstructive cardiomyopathy in a subject are provided. In some embodiments, the method comprises determining the amount of PIGF or a variant thereof in a sample of the subject, wherein an elevated amount of PIGF or a variant thereof is indicative for hypertrophic obstructive cardiomyopathy. In some embodiments, PIGF values ≧ about 12.4 pg/ml, suitably ≧ about 15.0 pg/ml, suitably ≧ about 16.7 pg/ml are indicative of hypertrophic obstructive cardiomyopathy.

In yet another illustrative embodiment, a method of deciding on the therapy for treating pathological left ventricular hypertrophy in a subject suffering from the disease is provided. In some embodiments, ;the method includes the steps of a) determining the amounts of at least one marker selected from necrosis markers, at least one marker selected from cardiac function markers and at least one marker selected from inflammatory markers, in at least one sample of said subject, b) comparing the amounts of the said markers as determined in step a) to suitable reference amounts, and c) deciding on the therapy, based on the comparison carried out in step b).

In some embodiments, the cardiac function marker is NT-proBNP or a variant thereof and an amount of NT-proBNP or a variant thereof of ≧ about 300 pg/ml indicates that agents effecting cardiac function, suitably selected from: beta blockers; nitrates; adrenergic agonists; positive inotropic agents; diuretics; should be administered. In some embodiments, the inflammatory marker is GDF-15 or a variant thereof and an amount of GDF-15 or a variant thereof of ≧ about 800 pg/ml indicates that anti-inflammatory drugs; angiotensin receptor antagonists and aldosterone antagonists; and/or statines; should be administered. In some embodiments, the necrosis marker is Troponin T or a variant thereof and an amount of Troponin T or a variant thereof of ≧ about 3 pg/ml indicates that percutane coronary intervention should be carried out. In some embodiments, additionally the level of PIGF is determined and an amount of PIGF or a variant thereof of ≧ about 8 pg/ml is indicative that a pro-angiogenic drug should be administered.

In yet another illustrative embodiment, methods of monitoring a therapy of treating pathological left ventricular hypertrophy in a subject suffering from the disease, are provided. In some embodiments, the methods include the steps of a) determining the amounts of at least one marker selected from necrosis markers, at least one marker selected from cardiac function markers and at least one marker selected from inflammatory markers, in at least one sample of said subject, b) comparing the amounts of the said markers as determined in step a) to suitable reference amounts, and c) adapting or discontinuing the therapy, based on the comparison carried out in step b). In some embodiments, the amount of PIGF or a variant thereof is measured. In some embodiments, the reference amounts are the amounts provided in one or more of the illustrative embodiments above, or are amounts determined before the therapy was initiated.

In some embodiments, a decrease or increase of 20% of the determined amounts in respect to the reference amounts, in case of a decrease of the marker amounts is indicative for an amelioration or, in case of an increase of the marker amounts is indicative of a deterioration of the pathological state of the subject.

In some embodiments, a transcoronary ablation of septum hypertrophy (TASH) has been carried out in a subject suffering from obstructive hypertrophic cardiomyopathy, a natriuretic peptide, suitably NT-proBNP or a variant thereof, is determined and a decrease of 20% in respect to the reference value is indicative of a successful TASH intervention.

In yet another illustrative embodiment, a device for carrying out the methods of any of previously described illustrative embodiments is provided. In some embodiments, the device includes: means for determining the amounts of each of the following peptides: a necrosis marker, suitably troponin or a variant thereof; a cardiac function marker, suitably a natriuretic peptide or a variant thereof; an inflammatory marker, suitably GDF-15 or a variant thereof; and means for comparing the amounts determined in step a) of said methods with reference amounts; and optionally means for determining the amount of PIGF or a variant thereof.

In yet another illustrative embodiment, kits adapted for carrying out the method of any of the previously described illustrative embodiments are provided. In some embodiments, the kits include: means for determining the amounts of each of the following peptides: a necrosis marker, suitably troponin or a variant thereof; a cardiac function marker, suitably a natriuretic peptide or a variant thereof; an inflammatory marker, suitably GDF-15 or a variant thereof; means for comparing the amounts determined in step a) with reference amounts of said methods, and instructions for carrying out the said method of the present invention; and optionally means for determining the amount of PIGF or a variant thereof.

In yet another illustrative embodiment, a method for facilitating a therapeutic decision in a subject suffering from left ventricular hypertrophy is provided. In some embodiments, the method includes a) determining the amounts of at least one necrosis marker (N), at least one cardiac function marker (CF), and/or at least one inflammatory marker (I) in at least one sample of the subject, wherein the amount of one or more markers in excess of a suitable reference amount is indicative of a need for a therapy for pathological left ventricular hypertrophy.

In some embodiments, the necrosis marker (N) comprises a cardiac troponin; and the cardiac marker comprises a natriuretic peptide. In some embodiments, the cardiac troponin is troponin I, troponin T or a variant thereof; the natriuretic peptide is BNP, NT-proBNP or a variant thereof; and the inflammatory marker (I) is GDF-15 or a variant thereof. In some embodiments, the necrosis marker is troponin T; and the cardiac function marker is NT-proBNP; and the inflammatory marker is GDF-15. In some embodiments, the following marker amounts in a subject sample are indicative of a need for therapy for pathological left ventricular hypertrophy: a) the troponin T at > about 5 pg/ml; b) the NT-proBNP at > about 75 pg/ml; and c) the GDF-15 at > about 600 pg/ml.

In some embodiments, a CF/I (cardiac function marker/inflammation marker) ratio between the amounts of a cardiac function marker and an inflammatory marker as determined in step a) greater than a suitable CF/I reference ratio is indicative of a need for a therapy for hypertrophic non-obstructive cardiomyopathy and the CF/I ratio less than the suitable CF/I reference ratio is indicative of a need for a therapy for hypertrophic obstructive cardiomyopathy or pressure overload hypertrophy. In some embodiments, the cardiac function marker includes a natriuretic peptide comprising a BNP-type marker selected from the group consisting of BNP, NT-proBNP and variants thereof. In some embodiments, the inflammatory marker is GDF-15 or a variant thereof.

In some embodiments, a N/I (necrosis marker/inflammatory marker) ratio between the amounts of a necrosis function marker and an inflammatory marker as determined in step a) greater than a suitable N/I high reference ratio is indicative of a need for a therapy for hypertrophic non-obstructive cardiomyopathy, the N/I ratio less than a suitable N/I low reference ratio is indicative of a need for a therapy for hypertrophic obstructive cardiomyopathy or pressure overload hypertrophy; and the N/I ratio between the suitable N/I low reference ratio and the suitable N/I high reference ratio is indicative of a need for a therapy for pressure overload hypertrophy. the necrosis marker comprises a cardiac troponin selected from the group consisting of troponin I, troponin T and variants thereof. In some embodiments, the inflammatory marker is GDF-15 or a variant thereof.

In some embodiments, a) the cardiac function marker is NT-proBNP, and an amount of NT-proBNP greater than about 300 pg/ml indicates a need to administer one or more cardiac agents selected from the group consisting of beta blockers, nitrates, adrenergic agonists, positive inotropic agents, and diuretics; b) the inflammatory marker is GDF-15, and an amount of GDF-15 greater than about 800 pg/ml indicates a need to administer one or more anti-inflammatory agents selected from the group consisting of angiotensin receptor antagonists, aldosterone antagonists, and statines; and c) the necrosis marker is troponin T, and an amount of troponin T greater than about 3 pg/ml indicates a need to treat the subject via percutane coronary intervention.

In some embodiments, the amount of PIGF in the at least one sample of the subject is determined.

In yet another illustrative embodiment, a method of facilitating a therapeutic decision for a subject suffering from left ventricular hypertrophy is provided. In some embodiments, the method includes determining an amount of PIGF or variant thereof in a sample of the subject, wherein an elevated amount of PIGF or variant thereof is indicative of a need for a therapy for hypertrophic obstructive cardiomyopathy. In some embodiments, a PIGF value greater than about 12.4 pg/ml indicates a need for a therapy for hypertrophic obstructive cardiomyopathy.

In yet another illustrative embodiments, a system is provided. In some embodiments, the system includes a) at least one reagent for determining the amount of each of the following markers in a subject sample: at least one necrosis marker, at least one cardiac function marker, at least one inflammatory marker; and b) suitable left ventricular hypertrophy (LVH) reference standards for each of the markers. In some embodiments, the system includes reagents for determining the amount of PIGF. In some embodiments, the system includes a reference component configured to facilitate a comparison of the determined amounts of each marker in the subject sample with the suitable LVH reference standards. In some embodiments, the system includes a ratio component configured to facilitate a comparison of a ratio of the determined amounts of any two of the markers in the subject sample with a suitable LVH reference ratio. In some embodiments, the system includes reagents for detecting the following markers: a) a necrosis marker (N) comprising a cardiac troponin; b) a cardiac function marker (CF) comprising a natriuretic peptide; and c) an inflammatory marker (I) comprising GDF-15 or a variant thereof. In some embodiments, the LVH reference standards include a) a reference standard for a necrosis marker (N) selected from the group of cardiac troponins consisting of troponin I, troponin T and variants thereof; b) a reference standard for a cardiac function marker (CF) comprising a natriuretic peptide comprising a BNP-type marker selected from the group consisting of BNP, NT-proBNP and variants thereof; and c) a reference standard for an inflammatory marker (I) comprising GDF-15 or a variant thereof. In some embodiments, the LVH reference standards include a) a reference level of troponin T at >5 pg/ml; b) a reference level of NT-proBNP at about 75 pg/ml; c) a reference level of GDF-15 at about 600 pg/ml. In some embodiments, the reference standards include a) a NT-proBNP/GDF-15 ratio value of about 0.43; b) a troponin T/GDF-15 high reference ratio value of about 0.01; and c) a troponin T/GDF-15 low reference ratio value of 0.004. In some embodiments, the system further includes: at least one reagent to detect PIGF; and a suitable PIGF left ventricle hypertrophy reference standard.

In yet another illustrative embodiment, a method for facilitating a therapeutic decision in a subject suffering from pathological left ventricular hypertrophy is provided. In some embodiments, the method includes a) determining the amounts of a cardiac functions marker and an inflammatory marker in at least one sample of the subject, wherein a CF/I ratio between the amounts of the cardiac function marker and the inflammatory marker as determined in step a) greater than a suitable CF/I reference ratio is indicative of a need for a therapy for hypertrophic non-obstructive cardiomyopathy and the CF/I ratio less than the suitable CF/I reference ratio is indicative of a need for a therapy for hypertrophic obstructive cardiomyopathy or pressure overload hypertrophy. In some embodiments, the cardiac function marker comprises a natriuretic peptide selected from the group consisting of BNP, NT-proBNP and variants thereof; and the inflammatory marker comprises GDF-15 or variants thereof.

In yet another illustrative embodiment, a method for diagnosing a subject suffering from pathological left ventricular hypertrophy, comprising: a) determining the amounts of a cardiac function marker and an inflammatory marker in at least one sample of the subject, wherein a CF/I ratio between the amounts of the cardiac function marker and the inflammatory marker as determined in step a) greater than a suitable CF/I reference ratio is indicative of the occurrence of hypertrophic non-obstructive cardiomyopathy and the CF/I ratio less than the suitable CF/I reference ratio is indicative of the occurrence of hypertrophic obstructive cardiomyopathy or pressure overload hypertrophy. In some embodiments, the cardiac function marker comprises a natriuretic peptide selected from the group consisting of BNP, NT-proBNP and variants thereof; and the inflammatory marker comprises GDF-15 or variants thereof.

In yet another illustrative embodiment, a method for facilitating a therapeutic decision in a subject suffering from pathological left ventricular hypertrophy is provided. In some embodiments, the method includes a) determining the amounts of necrosis marker and an inflammatory marker in at least one sample of the subject, wherein a N/I ratio between the amounts of the necrosis marker and the inflammatory marker as determined in step a) greater than a suitable N/I reference ratio is indicative of a need for a therapy for hypertrophic non-obstructive cardiomyopathy and the N/I ratio less than the suitable N/I reference ratio is indicative of a need for a therapy for hypertrophic obstructive cardiomyopathy or pressure overload hypertrophy. In some embodiments, the necrosis marker comprises a cardiac troponin selected from the group consisting of troponin I, troponin T and variants thereof and the inflammatory marker comprises GDF-15 or variants thereof.

In yet another illustrative embodiment, a method for diagnosing a subject suffering from pathological left ventricular hypertrophy is provided. In some embodiments, the method includes: a) determining the amounts of a necrosis marker and an inflammatory marker in at least one sample of the subject, wherein a N/I ratio between the amounts of the necrosis marker and the inflammatory marker as determined in step a) greater than a suitable N/I reference ratio is indicative of hypertrophic non-obstructive cardiomyopathy and the N/I ratio less than the suitable N/I reference ratio is indicative of hypertrophic obstructive cardiomyopathy or pressure overload hypertrophy. In some embodiments, the necrosis marker comprises a cardiac troponin selected from the group consisting of troponin I, troponin T and variants thereof and the inflammatory marker comprises GDF-15 or variants thereof.

In yet another illustrative embodiment, a method to facilitate a decision to adapt or discontinue a therapy to treat pathological left ventricular hypertrophy in a subject suffering from the disease is provided. In some embodiments, the method includes: a) determining the amounts of at least one necrosis marker, at least one cardiac function marker, and/or at least one inflammatory marker in at least one sample of the subject, wherein the amount of one or more markers in excess of or below a suitable reference amount is indicative of a need to adapt or discontinue a therapy.

In yet another illustrative embodiment, a system is provided. In some embodiments, the system includes a) at least one reagent for determining the amount of each of the following markers in a subject sample: at least one necrosis marker, at least one cardiac function marker, at least one inflammatory marker and a PIGF marker. In some embodiments, the system includes a reference component configured to facilitate a comparison of the determined amounts of each marker in the subject sample with suitable LVH reference standards. In some embodiments, the system includes a ratio component configured to facilitate a comparison of a ratio of the determined amounts of any two of the markers in the subject sample with a suitable reference ratio.

In further illustrative embodiments, a kit is provided. In some embodiments, the kit includes a) reagents for determining amounts of each of the following markers: at least one necrosis marker, at least one cardiac function marker, at least one inflammatory marker; and b) suitable reference standards for each of the markers.

In further illustrative embodiments, a kit for facilitating a therapeutic decision in a subject suffering from pathological left ventricular hypertrophy is provided. In some embodiments, the kit includes: reagents for determining amounts of each of the following markers: at least one necrosis marker, at least one cardiac function marker, at least one inflammatory marker and a PIGF marker.

In yet another illustrative embodiment, a subject evaluated by any of the above-illustrated embodiments has a glomerular filtration rate >60 ml/min.

### EXAMPLES

Methods

Troponin T was determined using Roche's electrochemiluminescence ELISA sandwich test Elecsys Troponin T hs (high sensitive) STAT (Short Turn Around Time) assay. The test employs two monoclonal antibodies specifically directed against human cardiac troponin T. The antibodies recognize two epitopes (amino acid position 125-131 and 136-147) located in the central part of the cardiac troponin T protein, which consists of 288 amino acids.

NT-proBNP was determined using Roche's electrochemiluminescence ELISA sandwich test Elecsys proBNP II STAT (Short Turn Around Time) assay. The test employs two monoclonal antibodies which recognize epitopes located in the N-terminal part (1-76) of proBNP (1-108).

To determine the concentration of GDF-15 in serum and plasma samples, an Elecsys prototype test using a polyclonal, GDF-15 affinity chromatography-purified, goat anti-human GDF-15 IgG antibody from R&D Systems (AF957) was developed. In each experiment, a standard curve was generated with recombinant human GDF-15 from R&D Systems (957-GD/CF). The results with new batches or recombinant GDF-15 protein were tested in standard plasma samples and any deviation above 10% was corrected by introducing an adjustment factor for this assay. GDF-15 measurements in serum and plasma samples from the same patient yielded virtually identical results after correction for eventual dilution factors. The detection limit of the assay was 200 pg/ml.

PIGF was determined using Roche's electrochemiluminescence ELISA sandwich test Elecsys PIGF STAT (Short Turn Around Time) assay. The test employs two monoclonal human PIGF specific antibodies (a biotinylated monoclonal antibody and an antibody labeld with a ruthenium complex).

### Example 1

A collective of 12 healthy competitive athletes having physiological left ventricular hypertrophy were examined during their active training period (i.e. not during holidays or the like where training was timely suspended or where the extent of training was reduced relative to the normal training period). In the course of the examination, the serum levels of NT-proBNP, GDF-15 and Troponin T were determined. The following results were found:

GDF-15: 397 pg/ml median; (25^{th} percentile: 360 pg/ml; 75^{th} percentile: 442 pg/ml); NT-proBNP: 15.72 pg/ml median; (25^{th} percentile: 6.48 pg/ml; 75^{th} percentile: 19.68 pg/ml); Troponin T: 3.94 pg/ml median; (25^{th} percentile: 3.30 pg/ml; 75^{th} percentile: 6.77 pg/ml)

The values were clearly below those determined in subjects suffering from pathological left ventricular hypertrophy (see example 2) and surprisingly show that healthy individuals suffering from physiological left ventricular hypertrophy can be distinguished from those having pathological hypertrophy on the basis of the above marker detection.

### Example 2

In individuals suspected to suffer from heart disease, signs of left ventricular hypertrophy were found by ECG examination. All individuals had a glomerular filtration rate (GFR) exceeding 60 ml/min, patients with renal hypertension were not included in the study.

Thereafter, individuals were diagnosed for hypertensive left ventricular hypertrophy (after exclusion of an aortic stenosis) by echocardiography and determination of blood pressure.

Hypertrophic cardiomyopathy was diagnosed by the exclusion of other known causes which may underlie left ventricular hypertrophy (arterial hypertension, see above; aortic stenosis and athlete's heart; genetic tests to verify the occurrence of hypertrophic cardiomyopathy were not done). In these individuals, obstructive hypertrophic cardiomyopathy was diagnosed if the left ventricular outflow gradient was above 30 mm Hg.

In all individuals, blood samples were taken and the amounts/levels of the respective peptides were determined, in serum samples as described in Example 1.

Patients diagnosed with obstructive hypertrophic cardiomyopathy suspected to suffer from a progressive disease and who were refractory in respect to medicament therapy, were treated by ablation after previous probatory occlusion of the feeding vessels. Blood samples were taken prior to and 6 months after intervention.

TABLE 1

| | NT-proBNP (pg/ml) | | | hsTnT (pg/ml) | | |
|---|---|---|---|---|---|---|
| | N = 19 | N = 11 | N = 12 | N = 19 | N = 11 | N = 12 |
| | HyN CMP | Hob CMP | Hyt CMP | HyN CMP | Hob CMP | Hyt CMP |
| Median | 351.0 | 229.0 | 203.6 | 8.2 | 7.8 | 11.8 |
| 75th perc. | 1084.4 | 1283.5 | 624.3 | 30.4 | 17.7 | 22.3 |
| 25th perc. | 248.0 | 111.4 | 73.0 | 5.8 | 2.4 | 6.8 |

| | PlGF (pg/ml) | | | GDF-15 (pg/ml) | | |
|---|---|---|---|---|---|---|
| | N = 19 | N = 11 | N = 12 | N = 19 | N = 11 | N = 12 |
| | HyN CMP | Hob CMP | Hyt CMP | HyN CMP | Hob CMP | Hyt CMP |
| Median | 8.9 | 15.0 | 10.8 | 969.2 | 1030.6 | 1387.2 |
| 75th perc. | 13.1 | 16.7 | 13.3 | 1657.3 | 2046.3 | 1628.0 |
| 25th perc. | 7.0 | 12.4 | 9.4 | 721.2 | 955.2 | 1110.7 |

TABLE 2

| | | N = 11 | | | N = 11 | |
|---|---|---|---|---|---|---|
| | N = 19 | Hypertrophic | | N = 19 | Hypertrophic | |
| | Hypertrophic | Obstructive | N = 12 | Hypertrophic | Obstructive | N = 12 |
| | CMP | CMP | Hyt CMP | CMP | CMP | Hyt CMP |
| | proBNP/GDF-15 | proBNP/GDF-15 | proBNP/GDF-15 | hsTnT/GDF-15 | hsTnT/GDF-15 | hsTnT/GDF-15 |
| | Ratio | Ratio | Ratio | Ratio | Ratio | Ratio |
| Median | 0.450 | 0.200 | 0.190 | 0.011194 | 0.002559 | 0.007880 |
| 75th perc. | 0.820 | 0.430 | 0.420 | 0.005628 | 0.002200 | 0.004787 |
| 25th perc. | 0.190 | 0.160 | 0.080 | 0.026497 | 0.006135 | 0.013570 |

TABLE 3

| | NT-proBNP (pg/ml) | | hs TnT (pg/ml) | | GDF-15 (pg/ml) | | PlGF (pg/ml) | |
|---|---|---|---|---|---|---|---|---|
| TASK | | After 6 | | After 6 | | After 6 | | After 6 |
| N = 71 Pat. | prae-TASH | month | prae-TASH | month | prae-TASH | month | prae-TASH | month |
| Median | 777.78 | 334.35 | 10.42 | 10.00 | 1079.68 | 1099.93 | 15.99 | 16.38 |
| 75th perc. | 1272.94 | 799.26 | 17.26 | 19.06 | 1372.7 | 1500.42 | 18.89 | 19.13 |
| 25th perc. | 190.67 | 126.71 | 6.09 | 5.69 | 817.28 | 792.86 | 13.39 | 14.17 |

In the tables 1, 2 and 3, the following abbreviations are used:
HyN CMP: hypertrophic cardiomyopathy (non-obstructive);
Hob CMP: hypertrophic obstructive cardiomyopathy;
Hyt CMP: hypertensive left ventricular hypertrophy

N is the number of patients enrolled in the study (19 for HyN CMP; 11 for Hob CMP; 12 for Hyt CMP. The amounts of PIGF and GDF-15, NT-proBNP and Troponin T were determined in serum samples.

The tables show:

Table 1: Concentrations of NT-proBNP, high sensitive Troponin T, PIGF and GDF-15 in patients with hypertrophic cardiomyopathy, hypertrophic obstructive cardiomyopathy and hypertensive left ventricular hypertrophy.

The 75^{th} and 25^{th} percentiles and the medians are indicated.

Table 2: ratios of NT-proBNP/GDF-15 and of high sensitive Troponin T/GDF-15 in patients with hypertrophic cardiomyopathy, hypertrophic obstructive cardiomyopathy and hypertensive left ventricular hypertrophy.

The 75^{th} and 25^{th} percentiles and the medians are indicated.

Table 3: Concentrations of NT-proBNP, high sensitive Troponin T, PIGF and GDF-15 in patients with hypertrophic obstructive cardiomyopathy, before TASH treatment (prae-TASH) and 6 months after TASH treatment.

The 75^{th} and 25^{th} percentiles and the medians are indicated.

The results are depicted in tables 1 and 2 show that the various forms of left ventricular hypertrophy can be distinguished via the determination of the levels/amounts of the peptides cited in the tables.

Furthermore, by a comparison of the values depicted in tables 1 and 2 with the values obtained from healthy individuals (see example 1), it is shown that it is possible to distinguish between these healthy individuals and individuals suffering from pathological left ventricular hypertrophy.

The values depicted in table 1 show that, relative to prae-TASH, the level of NT-proBNP was lower after a successful TASH therapy and that NT-proBNP can be used as indicator for a successful TASH treatment.

### Example 3:

In individuals suspected to suffer from heart disease, signs of hypertrophy were found by ECG examination. All individuals had a GFR exceeding 60 ml/min, patients with renal hypertension were not included in the study.

Thereafter, individuals were diagnosed for the various form of hypertrophy as described in Example 2, and the amounts of PIGF were determined. The following results were found:
Hob CMP: 15.0 pg/ml median; (25^{th} percentile: 12.4 pg/ml; 75^{th} percentile: 16.7 pg/ml);
HyN CMP: 8.9 pg/ml median; (25^{th} percentile: 7.0 pg/ml; 75^{th} percentile: 13.1 pg/ml); and
Hyt CMP: 10.8 pg/ml median; (25^{th} percentile: 9.4 pg/ml; 75^{th} percentile: 13.3 pg/ml)

The results show that subjects suffering from hypertrophic obstructive cardiomyopathy show the highest amounts/levels of PIGF. This gives additional information on the form of hypertrophy the individual suffers from and allows to rule in hypertrophic cardiomyopathy, in addition to the information provided by the amounts of the 3 other marker NT-proBNP, high sensitive Troponin T, and GDF-15 and, respectively, the rations thereof. The amount/level of PIGF even allows to diagnose hypertrophic obstructive cardiomyopathy in an individual, without referring to the other markers.

All references cited in this specification are herewith incorporated by reference with respect to their entire disclosure content and the disclosure content specifically mentioned in this specification.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within the known or customary practice in the art to which this disclosure pertains.

What is claimed is:

1. A method for facilitating a therapeutic decision in a subject suffering from left ventricular hypertrophy, comprising:
a) determining the amounts of at least one necrosis marker (N), at least one cardiac function marker (CF), and/or at least one inflammatory marker (I) in at least one sample of the subject,
wherein the amount of one or more markers in excess of a suitable reference amount is indicative of a need for a therapy for pathological left ventricular hypertrophy.

2. The method of claim 1, wherein the necrosis marker (N) comprises a cardiac troponin; and the cardiac marker comprises a natriuretic peptide.

3. The method of claim 2, wherein the cardiac troponin is troponin I, troponin T or a variant thereof; the natriuretic peptide is BNP, NT-proBNP or a variant thereof; and the inflammatory marker (I) is GDF-15 or a variant thereof.

4. The method of claim 1, wherein the necrosis marker is troponin T; and the cardiac function marker is NT-proBNP; and the inflammatory marker is GDF-15.

5. The method of claim 4, wherein the following marker amounts in a subject sample are indicative of a need for therapy for pathological left ventricular hypertrophy:
a) the troponin T at > about 5 pg/ml;
b) the NT-proBNP at > about 75 pg/ml; and
c) the GDF-15 at > about 600 pg/ml.

6. The method of claim 1, wherein a CF/I ratio between the amounts of a cardiac function marker and an inflammatory marker as determined in step a) greater than a suitable CF/I reference ratio is indicative of a need for a therapy for hypertrophic non-obstructive cardiomyopathy and the CF/I ratio less than the suitable CF/I reference ratio is indicative of a need for a therapy for hypertrophic obstructive cardiomyopathy or pressure overload hypertrophy.

7. The method of claim 1, wherein a N/I ratio between the amounts of a necrosis function marker and an inflammatory marker as determined in step a)
greater than a suitable N/I high reference ratio is indicative of a need for a therapy for hypertrophic non-obstructive cardiomyopathy,
the N/I ratio less than a suitable N/I low reference ratio is indicative of a need for a therapy for hypertrophic obstructive cardiomyopathy or pressure overload hypertrophy; and
the N/I ratio between the suitable N/I low reference ratio and the suitable N/I high reference ratio is indicative of a need for a therapy for pressure overload hypertrophy.

8. The method of claim 1, wherein:
a) the cardiac function marker is NT-proBNP, and an amount of NT-proBNP greater than about 300 pg/ml indicates a need to administer one or more cardiac agents selected from the group consisting of beta blockers, nitrates, adrenergic agonists, positive inotropic agents, and diuretics;
b) the inflammatory marker is GDF-15, and an amount of GDF-15 greater than about 800 pg/ml indicates a need to administer one or more anti-inflammatory agents selected from the group consisting of angiotensin receptor antagonists, aldosterone antagonists, and statines;
c) the necrosis marker is troponin T, and an amount of troponin T greater than about 3 pg/ml indicates a need to treat the subject via percutane coronary intervention.

9. The method of claim 1, further comprising determining the amount of PIGF in the at least one sample of the subject.

10. A method of facilitating a therapeutic decision for a subject suffering from left ventricular hypertrophy comprising:
determining an amount of PIGF or variant thereof in a sample of the subject,
wherein an elevated amount of PIGF or variant thereof is indicative of a need for a therapy for hypertrophic obstructive cardiomyopathy.

11. The method of claim 8, wherein the PIGF value greater than about 12.4 pg/ml indicates a need for a therapy for hypertrophic obstructive cardiomyopathy.

12. A system comprising:
a) at least one reagent for determining the amount of each of the following markers in a subject sample: at least one necrosis marker, at least one cardiac function marker, at least one inflammatory marker; and
b) suitable left ventricular hypertrophy (LVH) reference standards for each of the markers.

13. The system of claim 13, further comprising reagents for determining the amount of PIGF.

14. The system of claim 12, comprising a reference component configured to facilitate a comparison of the determined amounts of each marker in the subject sample with the suitable LVH reference standards.

15. The system of claim 12, comprising a ratio component configured to facilitate a comparison of a ratio of the determined amounts of any two of the markers in the subject sample with a suitable LVH reference ratio.

16. The system of claim 12, comprising reagents for detecting the following markers:
a) a necrosis marker (N) comprising a cardiac troponin;
b) a cardiac function marker (CF) comprising a natriuretic peptide; and
c) an inflammatory marker (I) comprising GDF-15 or a variant thereof.

17. The system of claim 12, wherein the LVH reference standards comprise:
a) a reference standard for a necrosis marker (N) selected from the group of cardiac troponins consisting of troponin I, troponin T and variants thereof;
b) a reference standard for a cardiac function marker (CF) comprising a natriuretic peptide comprising a BNP-type marker selected from the group consisting of BNP, NT-proBNP and variants thereof; and
c) a reference standard for an inflammatory marker (I) comprising GDF-15 or a variant thereof.

18. The system of claim 17, wherein the LVH reference standards comprise:
a) a reference level of troponin T at >5 pg/ml;
b) a reference level of NT-proBNP at about 75 pg/ml;
c) a reference level of GDF-15 at about 600 pg/ml.

19. The system of claim 17, wherein the reference standards comprise:
a) a NT-proBNP/GDF-15 ratio value of about 0.43;
b) a troponin T/GDF-15 high reference ratio value of about 0.01; and
c) a troponin T/GDF-15 low reference ratio value of 0.004.

20. The system of claim 12, further comprising:
at least one reagent to detect PIGF; and
a suitable PIGF left ventricle hypertrophy reference standard.
